(19) United States
(12) Patent Application Publication
(10) Pub. No.: US 2025/0380186 A1
(43) Pub. Date: Dec. 11, 2025

(54) METHODS, ARCHITECTURES, APPARATUSES AND SYSTEMS FOR EVALUATION OF SUCCESSFUL TRANSMISSIONS

(71) Applicant: InterDigital Patent Holdings, Inc., Wilmington, DE (US)

(72) Inventors: Chia-Hung Wei, Chesterbrook, PA (US); Martino Freda, Laval (CA); Pascal Adjakple, Great Neck, NY (US); Benoit Pelletier, Roxboro (CA); Ghyslain Pelletier, Montréal (CA)

(21) Appl. No.: 18/737,440

(22) Filed: Jun. 7, 2024

(51) Int. Cl. H04W 28/04; H04L 1/00; H04W 28/06

(52) U.S. Cl. CPC H04W 28/04; H04L 1/0076; H04W 28/06

(57) ABSTRACT

Procedures, methods, architectures, apparatuses, systems, devices, and computer program products for managing a NC process. In certain representative embodiments, a wireless transmit/receive unit (WTRU) may receive a Network Coding (NC) configuration from a network. The WTRU may receive a first protocol data unit (PDU) of a NC PDU set. The WTRU may associate the first PDU with a NC process based on header information. The NC process may successfully decode using the first PDU. The WTRU may receive a second PDU of the NC PDU set. The WTRU may discard the second PDU based on the second PDU being received within a NC process success release time duration from a time of the successful decoding of the NC process. The WTRU may release the NC process based on lapsing of the NC process success release time duration from a time of the successful decoding of the NC process.

### TECHNICAL FIELD

The present disclosure is generally directed to the fields of communications, software and encoding, including, for example, to methods, architectures, apparatuses, systems directed to Network Coding (NC), and more specifically to procedures to evaluate the successful transmission of protocol data units (PDUs) associated with a NC process.

### BACKGROUND

NC protocol is not currently supported in 3GPP radio protocols. In 3GPP radio protocol, each PDCP SDU has a one-to-one mapping with a PDCP PDU. In a receiving PDCP entity, successful reception of a Packet Data Convergence Protocol (PDCP) service data unit (SDU) using 3GPP radio protocol only requires a successful reception of a corresponding PDCP PDU. The receiving PDCP entity may deliver a PDCP status report to indicate to a transmitting entity which of the PDCP SDU(s) is correctly received or missed. After, corresponding PDCP PDU(s) may be retransmitted by the transmitting entity based on the PDCP status report. It would be beneficial to implement NC protocol in 3GPP radio protocols and to evaluate the successful transmission of PDUs associated with a NC process.

### SUMMARY

In certain representative embodiments, a wireless transmit/receive unit (WTRU) may associate a PDU with a NC process. For example, NC process management may be supported at a receiver, such as a PDCP entity which is implemented with a NC protocol.

In certain representative embodiments, a WTRU may maintain a NC process success release timer for a (e.g., each) NC process.

In certain representative embodiments, a WTRU may maintain a NC process stuck timer for a (e.g., each) NC process.

In certain representative embodiments, a WTRU may identify a NC process based on a sequence number (SN) of a PDU, a NC process success release timer, and/or NC process stuck timer.

In certain representative embodiments, a WTRU may (e.g., determine to) associate a received PDU and corresponding coding coefficients to a NC process based on a PDU SN, an order SN of the received PDU, and/or a NC process success release timer.

In certain representative embodiments, a WTRU may (e.g., determine to) discard a received PDU based on a PDU SN, an order SN of the received PDU, and/or a NC process success release timer.

In certain representative embodiments, a WTRU may (e.g., determine to) release a NC process based on a NC process success release timer and/or a NC process stuck timer.

In certain representative embodiments, a WTRU may receive a NC configuration from a network. The WTRU may receive a first PDU of a NC PDU set. The WTRU may associate the first PDU with a NC process based on header information (e.g., of the first PDU). The NC process may successfully decode using the first PDU. The WTRU may receive a second PDU of the NC PDU set. The WTRU may discard the second PDU based on the second PDU being received within a NC process success release time duration from a time of the successful decoding of the NC process. The WTRU may release the NC process based on lapsing of the NC process success release time duration from a time of the successful decoding of the NC process.

In certain representative embodiments, a WTRU may receive a NC configuration from a network. The WTRU may receive a first PDU of a NC PDU set. The WTRU may associate the first PDU with a NC process based on header information (e.g., of the first PDU). The WTRU may release the NC process and/or discard any PDUs associated with the NC process based on no other PDU associated with the NC process having been received during the NC process stuck time duration from a time of the receiving of the first PDU.

In certain representative embodiments, a WTRU may receive a NC configuration from a network. The WTRU may receive a first PDU of a NC PDU set. The WTRU may associate the first PDU with a NC process based on header information (e.g., of the first PDU). The WTRU may decode the NC process based on the NC configuration (e.g., the NC process stuck time duration not expiring).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a protocol layer diagram illustrating NC as a protocol in a PDCP layer;

FIG. 3 is a processing diagram illustrating an example processing flow for a NC protocol in a PDCP entity;

FIG. 4 is a processing diagram illustrating an example processing flow for segmented-SDU based NC at a transmitter;

FIG. 5 is a processing diagram illustrating an example processing flow for cross-SDU based NC at a transmitter;

FIG. 6 is a timing diagram illustrating an example communication flow between a transmitter and a receiver;

FIG. 7 is a timing diagram illustrating another example communication flow between a transmitter and a receiver;

FIG. 8 is a timing diagram illustrating another example communication flow between a transmitter and a receiver;

FIG. 9 is a scheduling diagram illustrating details of a communication flow between a transmitter and a receiver;

FIG. 10 algorithm diagram illustrating an example of determining a COUNT value;

FIG. 11 is a procedural diagram illustrating an example PDU processing flow;

FIG. 12 is a timing diagram illustrating an example usage of a NC process success release timer;

FIG. 13 is a timing diagram illustrating an example usage of a NC process stuck timer and a NC process success release timer;

FIG. 14 is a procedural diagram illustrating an example NC flow at a receiver;

FIG. 15 is a procedural diagram illustrating an example NC process release flow using a NC process stuck timer;

FIG. 16 is a procedural diagram illustrating an example NC process at a receiver;

FIG. 17 is a procedural diagram illustrating another example NC process at a receiver; and

FIG. 18 is a procedural diagram illustrating another example NC process at a receiver.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

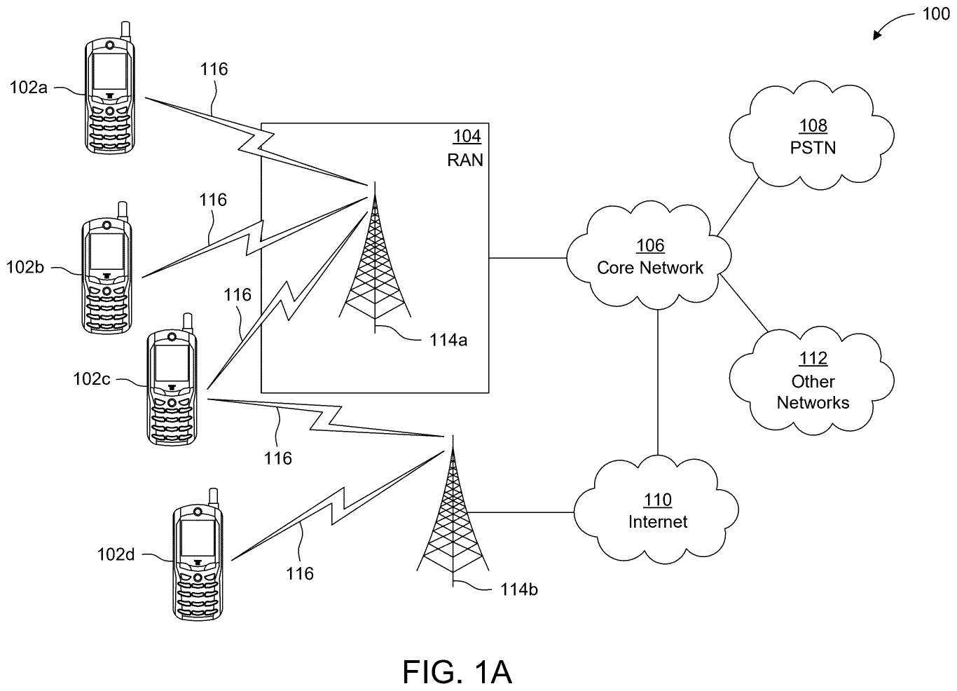

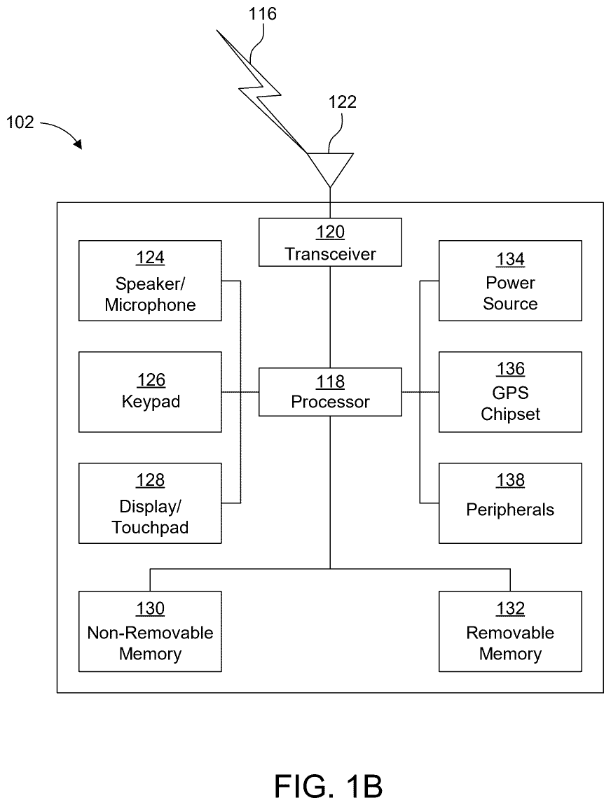

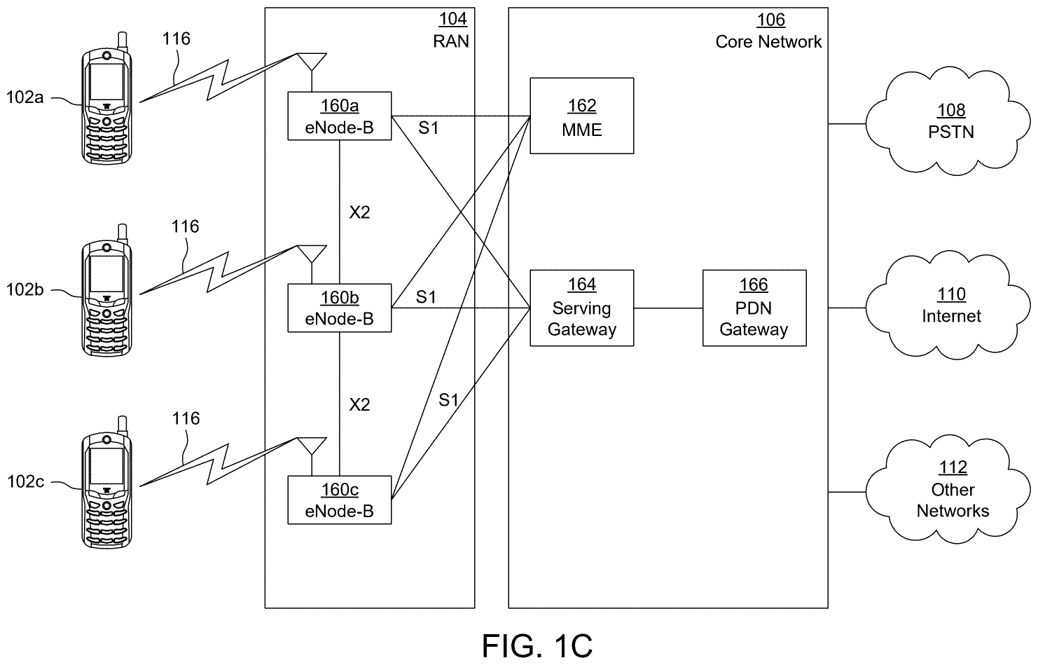

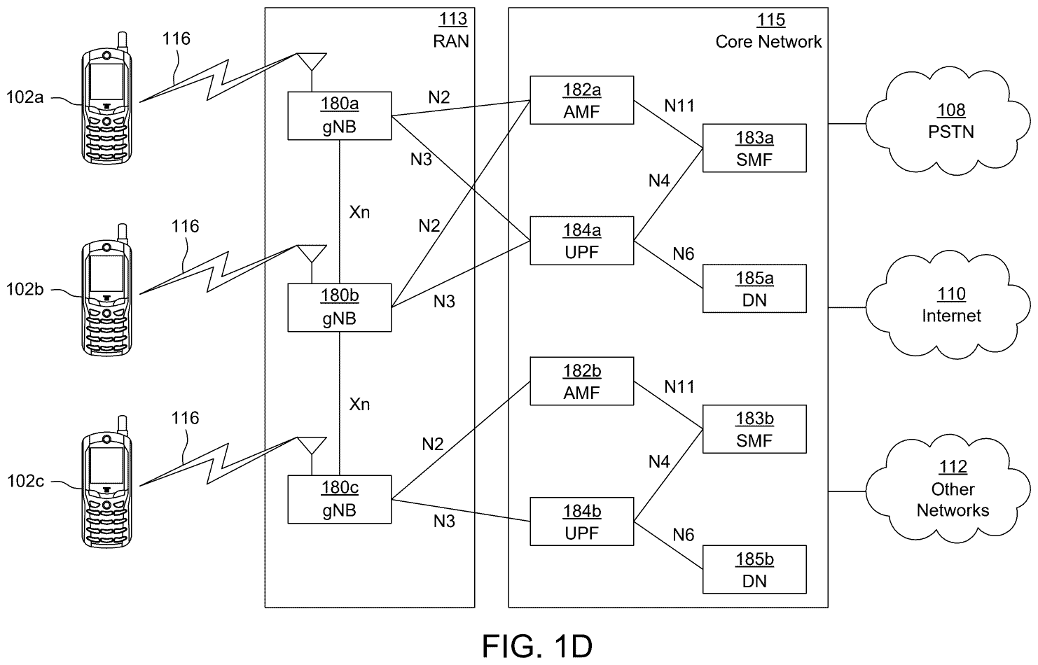

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

The following abbreviations and acronyms may be used herein:
CA Carrier Aggregation
CE Control Element
CORESET Control Resource Set
DC Dual Connectivity
DCI Downlink Control Information
DL Downlink
gNB Next Generation Node B
IAB Integrated access and backhaul
ID Identity
LSB Least Significant Bit
LTE Long Term Evolution e.g. from 3GPP LTE R8 and up
MBURLLC Joint URLLC and eMBB
NC Network Coding
NDI New Data Indicator
NR New Radio
OFDM Orthogonal Frequency-Division Multiplexing
PHY Physical Layer
PDCP Packet Data Convergence Protocol
PDU Protocol Data Unit
RLC Radio Link Control
RRC Radio Resource Control
RF Radio Front end
RRC Radio Resource Control
SDU Service Data Unit
SN Sequence Number
UE User Equipment
UL Uplink
URLLC Ultra-Reliable and Low Latency Communications

### NC Coding

In general, Network Coding (NC) refers to a packet processing protocol that transforms X input packet(s) into Y output packet(s). For example, X may be greater than or equal to 2 and Y may be greater than or equal to X, with the case X equal to 1 and Y equal to 1 being a special case. The X input packets being coded together form a network coding generation (e.g., otherwise referred to herein as a “generation”), where X is the generation size. An input packet may be an SDU or a segment of an SDU. An output packet may be denoted as PDU. Network coding is therefore a packet processing function that transform X SDU(s) into Y PDU(s). The PDUs associated with the same generation may be of the same or different characteristics, and therefore associated with a same or different importance/priority levels. Such characteristics may be systematic packets, coded packets, less-innovative coded packets, more-innovative coded packets, etc. Furthermore, there may be dependencies between PDUs of the same generation in the sense that: a) the receiver needs to receive Z PDUs or more to recover the SDUs X where Z is less than X; b) how many more PDUs or specific PDUs are needed by the receiver to recover the X SDUs depends on the PDUs already available at the receiver; and/or c) the scheduling of the PDUs of the same generation may be constrained by the same overall delay budget.

Benefits of NC includes improving reliability under tight latency requirements. NC may be applied with or without duplication, or with traditional packet repetition. The use of NC may alleviate a scheduler from having to select conservative MCS transmission parameters and/or improve the allocation of other transmission resources to improve overall system performance.

Network Coding may operate according to one or more network coding methods.

Examples of network coding methods may include any of the following: (i) segmented-SDU based NC; (ii) cross-SDUs based NC SDU; and/or (iii) hybrid based NC.

For example, segmented-SDU based NC may refer to a network coding scheme where an NC SDU is segmented into NC SDU segments, and packet generations include (e.g., only) NC SDU segments. Re-assembly of NC SDU segments may be performed at the end destination (e.g., decoder) to form the original NC SDU.

For example, cross-SDUs based NC SDU (e.g., concatenation-based NC) may refer to a network coding scheme where packet generations include (e.g., only) non-segmented SDUs.

For example, hybrid based NC may refer to a network coding scheme where a generation includes NC SDU segments which are segmented from more than one SDU.

### Examples of Use Cases and Deployments for NC

NC may be applied to (e.g., further) improve reliability and/or reduce latency of wireless transmissions in a number of connectivity scenarios and data services. For example, it may improve data transmissions for real-time immersive and multi-sensory communication and services, such as XR or Metaverse, as well as providing communication services required for connected industries and automation that may have latency requirements as low as sub-10 ms or even sub-ms ranges.

5G NR design supports PDCP duplications and other plain duplication redundancy techniques in support of ultra-reliable and low latency communication services. Considering increasing requirements in terms of various key performance metrics such as spectral efficiency, latency, reliability, data rate and the need for a concurrent support of these requirements, the use of redundancy via plain duplication as a solution is not efficient and not scalable.

Network coding can provide flexible redundancy coding rates for different reliability requirements and the flexible split of transmission of coded packets over different transmission paths (e.g. frequency diversity, spatial diversity, code diversity) or over different time instances (e.g., for time domain diversity).

In reference to the existing 5G system, network coding can be used to improve efficiency for the support of multicast broadcast services, sidelink services (e.g. V2X services), enhanced mobile broadband services with the added benefits of better link efficiency, reduced latency, improved reliability and reduced buffering requirements. Examples of deployment scenarios include CA (Carrier Aggregation), DC (Dual Connectivity), IAB (Integrated access and backhaul), and sidelink including sidelink relays.

### System Assumptions

As used herein, the term “system” may refer to the protocol stack defined by the 3rd Generation Partnership Project (3GPP) for the Radio Access Network (RAN) of New Radio (NR) mobile communication system.

In certain representative embodiments, NC may be implemented as a protocol in a PDCP layer.

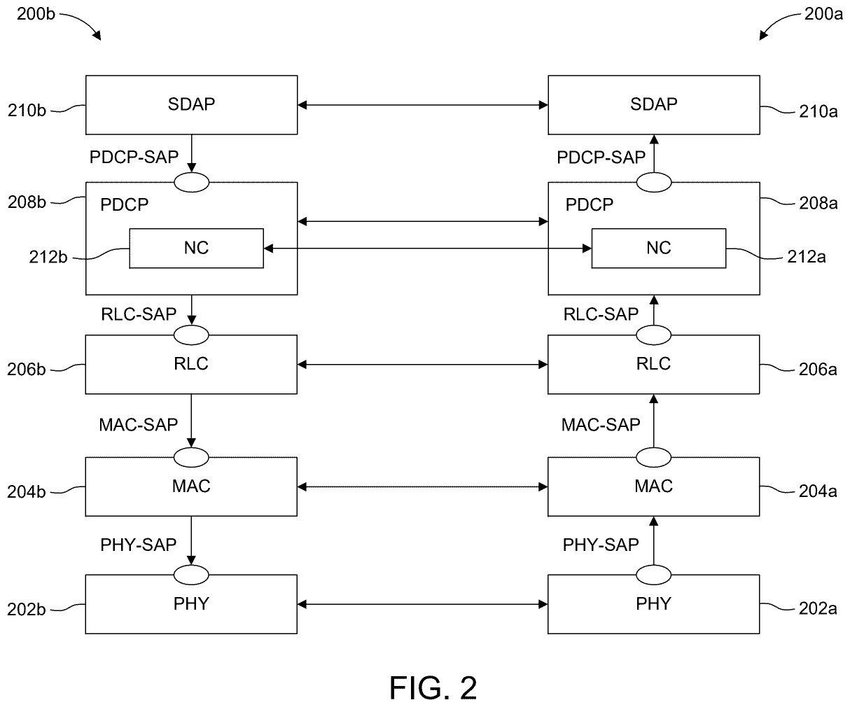

FIG. 2 is a protocol layer diagram illustrating NC as a protocol in a PDCP layer;

In FIG. 2, at a receiver side 200a a protocol stack may include a physical (PHY) layer 202a, a medium access control (MAC) layer 204a, a radio link control (RLC) layer 206a, a packet data convergence protocol (PDCP) layer 208a, and a service data adaptation protocol (SDAP) layer 210a. At a transmitter side 200b a protocol stack may include a PHY layer 202b, a MAC layer 204b, a RLC layer 206b, a PDCP layer 208b, and a SDAP layer 210b. At the PDCP level of the protocol stack, an NC encoding entity 212b may be implemented at the transmitter side 200b and NC decoding entity 212a may be implemented at the receiver side 200a.

In certain representative embodiments, in order to limit the impact on legacy functionalities, the NC protocol may be treated as a black box from the PDCP perspective. For example, it may be assumed the NC protocol is performed after PDCP header addition but before routing PDCP PDU(s) to a lower layer as illustrated in FIG. 2. That is, for each PDCP SDU, the PDCP entity generates a PDCP header to be attached to the each PDCP SDU before performing an NC encoding process. After the NC encoding process, the PDCP entity may route the output packet (e.g., PDCP PDU) to a lower layer.

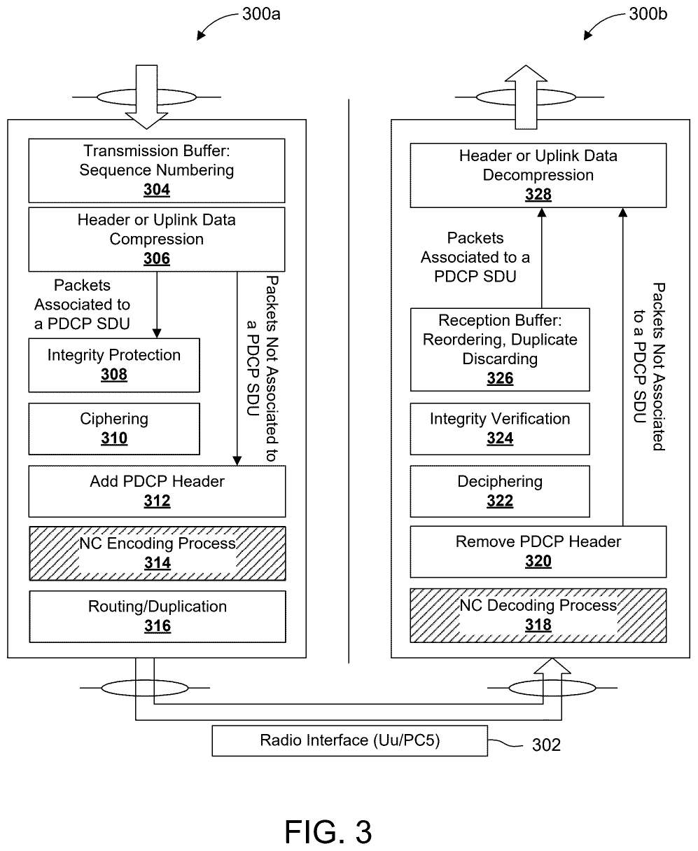

FIG. 3 is a processing diagram illustrating an example processing flow for a NC protocol in a PDCP entity.

As shown in FIG. 3, a transmitting PDCP entity 300a may communicate via a radio interface (e.g., Uu/PC5 interface) 302 with a receiving PDCP entity 300b. In certain representative embodiments, the transmitting PDCP entity 300a may be implemented in a WTRU 102 as a transmitter and the receiving PDCP entity 300b may be implemented in a NG-RAN as a receiver. In certain representative embodiments, the transmitting PDCP entity 300a may be implemented in a NG-RAN as a transmitter and the receiving PDCP entity 300b may be implemented in a WTRU 102 as a receiver. In certain representative embodiments, the transmitting PDCP entity 300a may be implemented in a WTRU 102 as a transmitter and the receiving PDCP entity 300b may be implemented in another WTRU 102 as a receiver.

At the transmitting PDCP entity 300a, data (e.g., packets) from an upper layer (e.g., SDAP) may be placed in a transmission buffer 304. For example, sequence numbering may be applied to the buffered packets. Header or uplink data compression may be performed at 306. For packets associated to a PDCP SDU, integrity protection may be performed at 308 and ciphering may be performed at 310. After ciphering and also for packets not associated to a PDCP SDU, a PDCP header may be added at 312. An NC encoding process may then be performed at 314. Routing and/or duplication of PDUs may be performed after NC encoding at 316.

At the receiving entity 300b, an NC decoding process may performed on received PDUs at 318. At 320, PDCP header removal may be performed. Deciphering may be performed at 322 and integrity verification may be performed at 324. At 326, packets may be placed in a reception buffer. Reordering and duplicate discarding may be performed. After PDCP header removal, packets not associated to a PDCP SDU may under go header or uplink data decompression at 328. For packets associated to a PDCP SDU in the reception buffer, header or uplink data decompression may be performed at 328. After decompression, data (e.g., packets) may be provided to an upper layer (e.g., SDAP).

In certain representative embodiments, the PDCP header may be assumed to be encoded by the NC protocol.

In certain representative embodiments, the PDCP header may not be encoded by the NC protocol and/or the NC protocol may be placed in different orders within a PDCP entity.

As used herein, the term “systematic PDU” may refer to a PDU carrying systematic packet.

As used herein, the term “non-systematic PDU” may be refer to a PDU carrying a non-systematic packet.

In certain representative embodiments, a timer may be considered to be running once it is started, until it is stopped or until it expires. Otherwise, the timer may not be considered to be running. A timer can be started if it is not running or restarted if it is running. A timer may (e.g., always) be started or restarted from its initial value. The duration of a timer may not be updated until it is stopped or expires.

As used herein, the term “timer” may refer to a time duration or interval which corresponds to an amount of time during which the timer is running (e.g., not stopped or expired).

### Overview

In certain representative embodiments, a receiver (e.g., a destination entity such as a WTRU 102) may evaluate whether or not transmissions (e.g., from a source entity such as a gNB 180) are successful at the PDCP layer.

By implementing NC protocol in PDCP, the one-to-one mapping relationship between a PDCP SDU and a PDCP PDU may no longer exist. That is, implementing the NC encoding process in a transmitting entity (e.g., a WTRU 102) may cause the transformation of PDCP SDUs to PDCP PDUs to become one-to-many or many-to-many. And since PDCP PDUs are transmitted individually by the transmitting entity, the receiving entity (e.g., a WTRU 102) may need to identify which NC process a receive PDU should be associated with, and whether a new NC process should be initiated for the received PDU. Furthermore, the receiving entity may need to manage an existing NC process. That is, it may be beneficial for the receiving entity to determine whether to associate received coded packets (e.g., PDUs) to a NC process.

In a case where Y coded packets are generated by a transmitting entity based on X source packet(s), then the X source packet(s) may be successfully decoded by the receiving entity based on at least X received coded packet(s) out of the Y coded packets. For the NC decoding process, it may be beneficial to the receiving entity to determine the linear relationship (e.g., equation) associated with each received PDCP PDU.

In legacy systems, a SDU may be discarded by a transmitting entity where the transmitting entity has received a PDCP status report from a receiving entity indicating the SDU has been successfully received by the receiving entity (e.g., receiving WTRU 102). After implementing the NC encoding process, a set of SDUs (e.g., a NC SDU set) may be bundled and used to generate a set of PDUs. In cases where only part of the SDUs belonging to the NC SDU set are successfully decoded and are indicated by the receiving entity as successfully received via a PDCP status report, discarding of the set of SDUs may result in the transmitting WTRU 102 not being able to generate additional PDUs based on the NC SDU set. Hence, it may be beneficial for the transmitting entity to determine when to discard a SDU in response to reception of a PDCP status report.

In certain representative embodiments, a PDU may be (e.g., determined to be) associated with a NC process of a SDU. For example, a WTRU 102 may discard PDUs associated to an already successfully decoded NC process within a specific time duration after successful detection. After the specific time duration has elapsed after successful detection, the WTRU 102 may release the NC process.

In certain representative embodiments, a WTRU 102 may be configured with a NC protocol. The WTRU 102 may associate a (e.g., received) PDU with a NC process.

In certain representative embodiments, a WTRU 102 may receive, from a network (e.g. via RRC messaging), configuration information associated with (e.g., a configuration for) NC. The configuration information may include information indicating any of a success release duration value and/or one or more NC process parameters. For example, the success release duration value may be indicative of a time duration (e.g., Duration_threshold) following a successful decoding of a NC process before the NC process is released.

In certain representative embodiments, the WTRU 102 may receive a first PDU from the network. The PDU header information associated with the PDU (e.g., the PDCP sub-header) may include (e.g., carry) information indicating any of a first NC PDU set sequence number (SN) and/or a first order SN.

In certain representative embodiments, the WTRU 102 may associate the first PDU with a NC process based on the first NC PDU set SN. For example, if no NC process is associated with the first NC PDU set SN exists, then the WTRU 102 may create a new NC process associated with the first NC PDU set SN according to the configuration information. For example, if there is an existing NC process associated with the first NC PDU set SN and there is a second PDU associated with the same NC process with the same order SN as the first PDU, the WTRU 102 may discard the first PDU. Otherwise, if the NC process has not been successfully decoded, the WTRU 102 may associate the first NC PDU to the NC process.

In certain representative embodiments, the WTRU 102 may successfully decode the NC process associated with the first PDU using the first PDU (e.g., also using any previously received PDUs associated to the same NC process).

In certain representative embodiments, the WTRU 102 may receive another (e.g., third) PDU from the network with the same NC PDU set SN as the first PDU. If the WTRU 102 determines that the third PDU is received within the configured success release duration time after the NC process has been successfully decoded, the WTRU 102 may discard the third PDU.

In certain representative embodiments, the WTRU 102 may release the NC process upon determining that the success release duration has elapsed since the NC process has been successfully decoded. For example, the WTRU 102 may discard all PDUs associated with the NC process.

In certain representative embodiments, the configuration information may include information indicating a stuck duration value. For example, the stuck duration value may be a time duration associated with the release of the NC process following no further PDU of the same NC PDU set being retrieved.

In certain representative embodiments, the WTRU 102 may discard any PDU(s) associated with the NC process if there is no PDU associated with the NC process that is received within the (e.g., configured) stuck duration time after a last PDU associated the NC process is received.

In certain representative embodiments, the WTRU 102 may release the NC process upon determining that the stuck duration time has elapsed since a last PDU associated the NC process is received.

In certain representative embodiments, the WTRU 102 may transmit a PDU discard indicator to the network upon the first (and/or third) PDU being discarded. For example, the PDU discard indicator may indicate the first (and/or third) PDU is discarded.

In certain representative embodiments, the WTRU 102 may transmit a NC process release indicator to the network upon the NC process being released. The NC process release indicator may indicate that the NC process is released.

### Common Aspects

In certain representative embodiments, a transmitting WTRU 102 may be configured with a NC protocol in the PDCP layer. The NC protocol may perform a NC encoding process which includes transforming X input packet(s) into Y output packet(s). The X input packet(s) may be denoted as a NC generation. The NC protocol supports multiple NC generations which may be NC encoded individually, such as in parallel. That is, each NC generation may be NC encoded independently based on an individual set of input packets (e.g., a set of SDUs for cross-SDU based NC, or a set of SDU segments for segmented-SDU based NC).

For example, an NC encoding process may be performed using different approaches, such as segmented-SDU based and cross-SDU based encoding, each of which may be implemented as several stages.

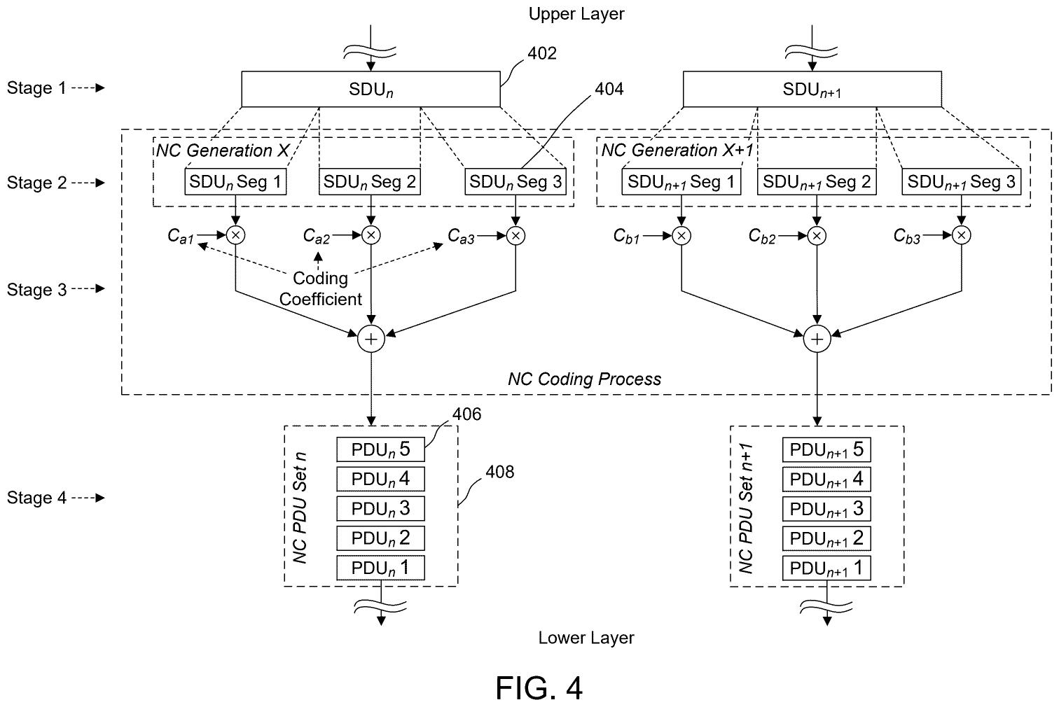

FIG. 4 is a processing diagram illustrating an example processing flow for segmented-SDU based NC at a transmitter. As shown in FIG. 4, the segmented-SDU based NC may be represented as four stages of operation.

At stage 1, one or more SDUs 402a, 402b are received from upper layers by a transmitting WTRU 102. The transmitting WTRU 102 may perform none, or one or more pre-process(es) for the one or more SDUs. For example, the pre-process may be, but are not limited to, legacy procedures in the PDCP layer as in FIG. 3 (e.g., transmitting PDCP entity). For example, sequence numbering, header compression, uplink data compression, integrity protection, and/or ciphering may be included in the pre-processing.

At stage 2, each of the one or more SDUs 402 may be segmented into multiple SDU segments 404 (e.g., by the NC coding protocol). As used herein, the terms “SDU segment”, “segmented SDU” and/or “segment of SDU” may be used interchangeably.

At stage 3, NC encoding may be performed using the SDU segments 404 and applying coding coefficients associated with each of SDU segments 404. For example, the coding coefficients may be, but are not limited to be, values which are derived based on one or more pre-configured coefficients. For example, the coding coefficients may be selected based on the order of the SDU segments 404 within the original SDU 402.

At stage 4, one or more PDUs 406 may be generated (e.g., as a NC PDU Set 408). For example, the transmitting WTRU 102 may perform none, or one or more post-processes on the one or more PDUs 406. For example, the post-processes may be, but are not limited to, legacy procedures in the PDCP layer. The one or more PDUs may be delivered to a lower layer (e.g., for transmission).

As shown in FIG. 4, the following may apply. SDUₙ may refer to the input packet n of the NC encoding process. SDUₙ Seg X may refer to the X-th segment of SDUₙ. PDUₙ X may refer to the X-th output packet of the NC encoding process by using SDUₙ. Cₐ₁ may refer to the 1st coding coefficient of a coefficient vector a. For example, a coefficient vector may be assumed to have one or more coding coefficients. NC PDU set n may refer to a set of coded packets encoded by using SDUₙ.

In FIG. 4, the transmitting WTRU 102 receives SDUₙ and SDUₙ₊₁ from upper layers sequentially. The SDUₙ and SDUₙ₊₁ are processed via individual NC processes, respectively. That is, the SDUₙ is segmented into N segments (e.g., N is equal to 3 in this example, such that there are SDUₙ Seg 1, SDUₙ Seg 2, and SDUₙ Seg 3). The SDUₙ Seg 1, SDUₙ Seg 2, and SDUₙ Seg 3 are denoted as NC generation X. The NC generation X is encoded by applying N coding coefficients for each generated coded packets (e.g., one coding coefficient per SDU-segment for each coded packet) and then generates multiple coded packets (e.g., PDUₙ 1, PDUₙ 2, PDUₙ 3, PDUₙ 4 and PDUₙ 5). The coded packets associated with a same NC generation are denoted as belonging to a same NC PDU set. That is, the PDUₙ 1, PDUₙ 2, PDUₙ 3, PDUₙ 4 and PDUₙ 5 are considered to belong to the NC PDU set n. Alternatively, it can be interpreted as the NC PDU set n contains the PDUₙ 1, PDUₙ 2, PDUₙ 3, PDUₙ 4 and PDUₙ 5. In this example with a generation size N=3, the coding coefficients Cₐ₁, Cₐ₂ and Cₐ₃ are represented as three coding coefficient vectors applied to encode SDUₙ Seg 1, SDUₙ Seg 2, and SDUₙ Seg 3.

Each coding vector may contain multiple coding coefficients, and each of the PDUₙ 1, PDUₙ 2, PDUₙ 3, PDUₙ 4 and PDUₙ 5 may be generated by applying coding coefficients of different coefficient vectors.

In a similar manner, the SDUₙ₊₁ is segmented into multiple segments (e.g., SDUₙ₊₁ Seg 1, SDUₙ₊₁ Seg 2, and SDUₙ₊₁ Seg 3). The SDUₙ₊₁ Seg 1, SDUₙ₊₁ Seg 2, and SDUₙ₊₁ Seg 3 are denoted as NC generation Y. The NC generation Y is encoded by applying coding coefficients and then generating multiple coded packets (e.g., PDUₙ₊₁ 1, PDUₙ₊₁ 2, PDUₙ₊₁ 3, PDUₙ₊₁ 4 and PDUₙ₊₁ 5). The PDUₙ₊₁ 1, PDUₙ₊₁ 2, PDUₙ₊₁ 3, PDUₙ₊₁ 4 and PDUₙ₊₁ 5 are considered to belong to the NC PDU set n+1. Alternatively, it can be interpreted as the NC PDU set n+1 contains the PDUₙ₊₁ 1, PDUₙ₊₁ 2, PDUₙ₊₁ 3, PDUₙ₊₁ 4 and PDUₙ₊₁ 5. The coding coefficients C_{b1}, C_{b2} and C_{b3} are represented as three coding coefficients applied to encode SDUₙ₊₁ Seg 1, SDUₙ₊₁ Seg 2, and SDUₙ₊₁ Seg 3. Each coefficient vector may contain multiple coefficient coefficients, and each of the PDUₙ₊₁ 1, PDUₙ₊₁ 2, PDUₙ₊₁ 3, PDUₙ₊₁ 4 and PDUₙ₊₁ 5 may be generated by applying coding coefficients within different coding vectors.

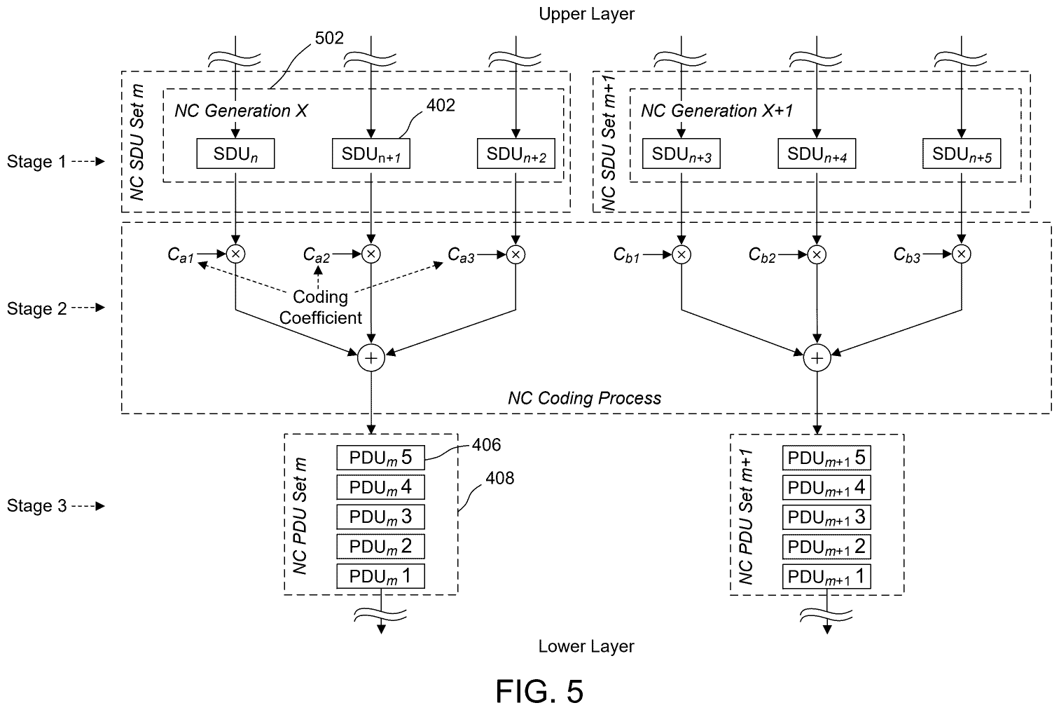

FIG. 5 is a processing diagram illustrating an example processing flow for cross-SDU based NC at a transmitter. As shown in FIG. 5, the cross-SDU based NC may be represented as three stages of operation.

At stage 1, one or more SDUs are received from upper layers by a transmitting WTRU 102. The transmitting WTRU 102 may perform none, or one or more pre-process(es) for the one or more SDUs 402. For example, the pre-process may be, but are not limited to, legacy procedures in the PDCP layer as in FIG. 3. The transmitting WTRU 102 may group multiple SDUs 402 as a NC SDU set (e.g., NC generation) 502 for a NC encoding process.

At stage 2, NC encoding may proceed (e.g., by the NC coding protocol) by using the NC SDUs 402 of the NC SDU set 502 and by applying the coding coefficients associated with each of the SDUs 402 of the NC SDU set 502. For example, the coding coefficients may be, but are not limited to be, values which are derived based on one or more pre-configured coefficients. The coding coefficients may be selected based on an order of each SDU 402 within the NC SDU set 502.

At stage 3, NC coding protocol may generate one or more PDUs 406 (e.g., a s a NC PDU Set 408). For example, the transmitting WTRU 102 may perform none, or one or more post-processes on the one or more PDUs 406. For example, the post-processes may be, but are not limited to, legacy procedures in the PDCP layer. The one or more PDUs 406 may be delivered to a lower layer (e.g., for transmission).

As shown in FIG. 5, the following may apply. SDUₙ may refer to the input packet n of a NC encoding process. NC SDU Set m may refer to the input packet set m of the NC encoding process. The SDU Set m may be referred to as a NC generation. PDUₘ X may refer to the X-th output packet of the NC encoding process by using the NC SDU set m. Cₐ₁ may refer to the 1st coding coefficient of coefficient vector a. A coefficient vector may be assumed to have one or more coding coefficients. NC PDU set m may refer to a set of coded packets encoded by using the NC SDU Set m.

In FIG. 5, the transmitting WTRU 102 may group N SDUs 402 as a NC SDU set 502, such as where N is equal to 3. That is, the transmitting WTRU 102 receives SDUₙ, SDUₙ₊₁, SDUₙ₊₂, SDUₙ₊₃, SDUₙ₊₄, and SDUₙ₊₅ from the upper layers sequentially. The SDUₙ, SDUₙ₊₁ and SDUₙ₊₂ are grouped as NC SDU set m. The SDUₙ₊₃, SDUₙ₊₄, and SDUₙ₊₅ are grouped as NC SDU set m+1. NC SDU set m and NC SDU set m+1 are denoted as NC generation X and NC generation Y respectively. The SDUₙ, SDUₙ₊₁ and SDUₙ₊₂ are encoded by applying N coding coefficients for each of the generated coded packets (e.g., one coding coefficient per SDU for each coded packet) and then generates multiple coded packets (e.g., PDUₘ 1, PDUₘ 2, PDUₘ 3, PDUₘ 4 and PDUₘ 5). The coded packets associated with a same NC generation are denoted as belonging to the same NC PDU set. That is, PDUₘ 1, PDUₘ 2, PDUₘ 3, PDUₘ 4 and PDUₘ 5 belong to the NC PDU set m. Alternatively, it can be interpreted as the NC PDU set m contains the PDUₘ 1, PDUₘ 2, PDUₘ 3, PDUₘ 4 and PDUₘ 5. With a generation size of N=3, the coding coefficient Cₐ₁, Cₐ₂ and Cₐ₃ may be represented as three coding coefficient vectors applied to encode SDUₙ, SDUₘ₊₁ and SDUₙ₊₂. Each coding vector may contain multiple coefficient coefficients, and each of the PDUₘ 1, PDUₘ 2, PDUₘ 3, PDUₘ 4 and PDUₘ 5 may be generated by applying coding coefficients of different coefficient vectors. Similarly, the SDUₙ₊₃, SDUₙ₊₄, and SDUₙ₊₅ are encoded by applying coding coefficients and then generating multiple coded packets (e.g., PDUₘ₊₁ 1, PDUₘ₊₁ 2, PDUₘ₊₁ 3, PDUₘ₊₁ 4 and PDUₘ₊₁ 5). The PDUₘ₊₁ 1, PDUₘ₊₁ 2, PDUₘ₊₁ 3, PDUₘ₊₁ 4 and PDUₘ₊₁ 5 may belong to NC PDU set m+1. Alternatively, it can be interpreted as the NC PDU set m+1 contains the PDUₘ₊₁ 1, PDUₘ₊₁ 2, PDUₘ₊₁ 3, PDUₘ₊₁ 4 and PDUₘ₊₁ 5. The coding coefficients C_{b1}, C_{b2} and C_{b3} are represented as three coding coefficients applied to encode the SDUₙ₊₃, SDUₙ₊₄, and SDUₙ₊₅. Each coding vector may contain multiple coding coefficients, and each of the PDUₘ₊₁ 1, PDUₘ₊₁ 2, PDUₘ₊₁ 3, PDUₘ₊₁ 4 and PDUₘ₊₁ 5 may be generated by applying coding coefficients of different coefficient vectors.

It is noted that, the SDU(s) and PDU(s) here in the present disclosure may be interpreted as the input packets of the NC protocol and the output packets of the NC protocol, respectively. For example, a SDU 402 may be pre-processed by legacy procedure(s) in the PDCP layer before input to the NC protocol. A PDU 406 may be post-processed by legacy procedure(s) in the PDCP layer after output from the NC protocol.

### Common Terminology

The term “coefficient matrix” may refer to a matrix carrying a set of coding coefficients. Each coefficient matrix may contain one or multiple rows and one or multiple columns.

The term “coefficient vector” may refer to a set of coding coefficients which may be either a row of a coefficient matrix or a column of a coefficient matrix.

The term “coding coefficient” may refer to a scalar value from a finite field (e.g., a field that contains a finite number of elements). A field is a set on which addition, subtraction, multiplication, and division are defined and behave as the corresponding operations on rational and real numbers do. As with any field, a finite field is a set on which the operations of multiplication, addition, subtraction and division are defined and satisfy basic rules of arithmetic, with the result of such operation being an element of the said finite field. In the case the field is a binary extension field, the coefficients are elements of a field of size 2⁵ (e.g., number of elements in the field) where s is the size (or length in bit) of the coefficient. Examples of binary extension fields include binary field (2) where each element is one bit long, binary-2 field GF (2⁴) where each element is 2 bits long, binary-4 field GF (2⁴) where each element is 4 bits long, and binary-8 field GF (2⁵) where each element is one byte long. In enumerated form, (2) is the set {0,1}, GF (2²) is the set {00,01,10,11}, GF (2⁴) is the set {0000,0001,0010,0011, 0100,0101,0110, 0111, 1000, 1001, 1010, 1011, 1100, 1101, 1110, 1111}, and so forth. Since a packet size is usually larger than the field size, each packet is seen as a set of elements from the Galois field (e.g., usually referred to as symbols) appended together. Network coding arithmetic operations are symbols wise operations because the coding coefficients and the symbols of the packets being coded together are of the size, and are elements of the same finite filed.

For example, the coefficients may be configuration based. They can be randomly selected from a finite field or a generator matrix (e.g., look up table) configured at the WTRU 102, or selected deterministically based on a finite field or a generator matrix configured at the WTRU 102 according to a specified algorithm.

The term “NC process” may refer to NC decoding of a NC PDU set. A NC process (e.g., NC context) may be initiated by a receiving WTRU 102 for a NC PDU set. The NC process is initiated for NC decoding. The NC process may perform at least the NC decoding for the NC PDU set and also maintaining the NC context related to the NC PDU set. A PDU belonging to a NC PDU set will be associated with a NC process initiated for the NC PDU set. That is, different NC PDU sets may be NC decoded by different NC processes. Hence, the receiving WTRU 102 may initiate a NC process for each NC PDU set. And PDUs belonging to a same NC PDU set may be associated with the same NC process.

A NC process may be released by the receiving WTRU 102 in response to one or more condition(s) having been satisfied. That is, a NC process may keep performing NC decoding after the NC process is initiated and before the NC process is released.

In certain representative embodiments, a NC context (e.g., NC process) may include any of the following: (i) a context identifier (e.g., context ID), (ii) a context sequence number, (iii) a coefficient (e.g., generator) matrix, (iv) a coefficient (e.g., generator) matrix ID, (v) NC SDU segments or group of NC SDUs being jointly coded together, (vi) a NC generation sequence number, (vii) NC PDUs, and/or (viii) a mapping between NC SDUs and NC PDUs (e.g., using respective sequence information).

The term “active NC process” may refer to a NC process once it has been initiated and prior to being released.

For segmented-SDU based NC, a NC process may be successfully decoded. The term “successfully decoded” may refer to any of: (i) a SDU being successfully decoded by the NC process, (ii) a SDU being recovered by the NC process; (iii) the NC process is associated with a NC PDU set, and a SDU associated with the NC PDU set has been successfully decoded by the NC process; (iv) the NC process is associated with a NC PDU set, and a SDU associated with the NC PDU set has been successfully decoded by the NC process by using the NC PDU set; and/or (v) decoding using the NC process is complete.

For cross-SDU based NC, a NC process may be successfully decoded. The term “successfully decoded” may refer to any of: (i) all SDUs have been successfully decoded by the NC process; (ii) all SDUs have been recovered by the NC process; (iii) the NC process is initiated for a NC PDU set, and all SDUs associated with the NC PDU set have been successfully decoded by the NC process; (iv) the NC process is initiated for a NC PDU set, and all SDUs associated with the NC PDU set have been successfully decoded by the NC process by using the NC PDU set; and/or (v) decoding using the NC process is complete.

In certain representative embodiments, a WTRU 102 may be configured with a NC protocol and/or mode. For example, a WTRU 102 may be configured with either a segmented-SDU mode (e.g., NC protocol) or a cross-SDUs mode (e.g., NC protocol) to be operated in PDCP layer. The NC protocol may be configured by a gNB. That is, the NC protocol may be configured via downlink RRC signaling (e.g., dedicated signaling or broadcasted signaling).

### NC Configuration

In certain representative embodiments, a (e.g. transmitting and/or receiving) WTRU 102 may receive information indicating a NC configuration to support NC protocol operation (e.g., encoding or decoding).

In certain representative embodiments, a (e.g. transmitting and/or receiving) WTRU 102 may receive (e.g., by DL RRC messaging) information indicating a NC configuration from a gNB 180. For example, the NC configuration may include information indicating any of: (i) one or more of coefficient matrices; (ii) a success release duration; (iii) a stuck duration; (iv) a Duration_threshold parameter; and/or (v) a NC_PDU_set_SN_range parameter. A coefficient matrix may contain one or more rows and/or one or more columns. Each row may be represented as a coefficient vector. Each coefficient vector may contain one or more coding coefficients. As an example, each coefficient matrix may be associate with a coefficient matrix index and/or each coefficient vector may be associate with a coefficient vector index. For example, the success release duration may indicate an initial value of a NC process success release timer. For example, the stuck duration may indicate an initial value of a NC process stuck timer (e.g., interval or duration). For example, the Duration_threshold may indicate a length of a time duration following the NC process being successful decoded before the NC process is released. For example, the NC_PDU_set_SN_range may indicate a range of NC PDU set SNs.

In certain representative embodiments, a NC configuration may be, but is not limited to, or included in a radio bearer and/or a PDCP specific configuration. That is, for different PDCP entities and radio bearers configured with NC protocol, respectively, the gNB 180 may provide individual NC configurations for each of the configured NC protocols.

For example a NC configuration may be configured by RRC signaling, Downlink Control Indicator (DCI), MAC Control Element (CE), Layer 1 and/or Layer 2 signaling.

In certain representative embodiments, a coefficient matrix may be pre-defined in a technical specification (e.g., 3GPP TS).

In certain representative embodiments, a NC configuration may be pre-defined in a technical specification (e.g., 3GPP TS).

In certain representative embodiments, “starting a NC process success release timer” may refer to the setting of an initial value of a NC process success release timer to the success release duration and then starting the NC process success release timer.

In certain representative embodiments, “starting a NC process stuck timer” may refer to the setting of an initial value of a NC process stuck timer to the NC process stuck duration and then starting the NC process stuck timer.

### PDU Identification

In certain representative embodiments, a transmitting WTRU 102 may assign an order SN to a PDU based on a type of the PDU and/or based on an order of the PDU within a NC PDU set, and assigns a NC PDU set SN to each PDU based on an association of the PDU with the NC PDU set.

In certain representative embodiments, after a NC encoding process is performed at a transmitting WTRU 102 by using a NC generation, the NC encoding process may generate multiple PDUs. The multiple PDUs may be referred to as a NC PDU set. That is, the NC PDU set may contain multiple PDUs.

To assist a receiving WTRU 102 to identify an order of a PDU within a NC PDU set, the transmitting WTRU 102 may assign an order SN to the PDU. In addition, to assist the receiving WTRU 102 to identify an association of a PDU with the NC PDU set, the transmitting WTRU 102 may assign a NC PDU set SN to the PDU. For example, each PDU within the NC PDU set may be assigned with an order SN and a NC PDU set SN.

For example, a value of an order SN assigned to a PDU may be determined based on the order of the PDU within a NC PDU set to which the PDU belongs. For example, a value of a NC PDU set SN assigned to the PDU may be determined based on an association of the PDU with the NC PDU set to which the PDU belongs.

In other words, to assist a receiving WTRU 102 to identify an order within a NC PDU set of each received PDU, the order SNs assigned to the received PDUs may have different values. Furthermore, to assist the receiving WTRU 102 to identify the association with an NC PDU set for each received PDU, the NC PDU set SN assigned to each received PDU may have a common value.

In certain embodiments, the value of the NC PDU set SN may be set to the value of the NC PDU set identifier.

### Association of a PDU to a NC Process

In certain representative embodiments, a (e.g., receiving) WTRU 102 may determine to associate a received PDU with a NC process based on (e.g., at least) any of an order SN of the received PDU, an NC PDU SN of the received PDU, and/or a NC process success release timer.

In certain representative embodiments, the (e.g., receiving) WTRU 102 may receive a PDU, and the WTRU 102 may determine whether to associate the PDU with a NC process for a corresponding NC decoding process. The NC process may be either an existing NC process or a newly initiated NC process. The existing NC process may be interpreted as a NC process which was initiated before, and the NC process is not released. Specifically, the NC process may be identified by at least a NC PDU set SN of the PDU.

In certain representative embodiments, the WTRU 102 may determine not to associate the PDU to a NC process, and the WTRU 102 may discard the PDU.

In certain representative embodiments, the determination of whether to associate a PDU to a NC process may be based on one or more conditions. In certain representative embodiments, the one or more condition(s) may be categorized in several approaches follows.

For example, a PDU may be associated with a NC process based on SN information. A receiving WTRU 102 may determine whether to associate a PDU with a NC process based on one or more of SN(s) of the PDU (e.g., any the SN(s) carried by the SN and/or associated with the PDU).

In some representative embodiments, the determination may include the receiving WTRU 102 identifying which (e.g., existing) NC Process the PDU should be associated with based on the one or more of SN(s). For example, after a WTRU 102 receives a first PDU with a first NC PDU set SN, the WTRU 102 may determine to associate the first PDU to a NC process which was (e.g., previously) initiated by a second PDU in cases where the value of the first PDU set SN is equal to the value of the second NC PDU set SN.

In some representative embodiments, the determination may include the receiving WTRU 102 determining whether to initiate a NC process for the PDU. For example, after a WTRU 102 receives a first PDU with a first NC PDU set SN, the WTRU 102 may determine to initiate a new NC process for the first PDU in cases where all active NC processes were not initiated for the first NC PDU set. That is, there is no active NC process which was previously initiated by a PDU with a NC PDU set SN having a value equal to the value of the first NC PDU set SN.

In some representative embodiments, the determination may include the receiving WTRU 102 determining whether the PDU is a duplicated PDU based on the one or more of SN(s). For example, after a WTRU 102 receives a first PDU with a first NC PDU set SN and a first order SN, the WTRU 102 may determine whether the PDU is a duplicated PDU based on at least the first NC PDU set SN and the first order SN. In cases where the PDU is determined to be a duplicated PDU, the PDU may be discarded by the receiving WTRU 102. That is, the receiving WTRU 102 may not associate the PDU to any NC process in cases where the PDU is a duplicated PDU.

For example, after a WTRU 102 receives a first PDU with a first NC PDU set SN and a first order SN, the WTRU 102 may determine the PDU is a duplicated PDU if: (i) there is at least a second NC process which is an active NC process, and the second NC process was initiated for a NC PDU set with a NC PDU set SN having a value equal to the value of the first NC PDU set SN; and (ii) there is a second PDU with a second NC PDU set SN and a second order SN that has been received, and the value of the second NC PDU set SN is equal to the value of the first NC PDU set SN, and the value of the second order SN is equal to the value of the first order SN.

For example, a PDU may be associated with a NC process based on usage of a timer (e.g., lapsing of a time amount). A receiving WTRU 102 may, for each initiated NC process, maintain a NC process success release timer. The receiving WTRU 102 may determine whether to associate a received PDU to a NC process based on the NC process success release timer associated with the NC process.

In certain representative embodiments, the NC process success release timer may be started when SDU(s) or SDU-segments of a NC generation are recovered following the decoding of PDUs associated with the NC generation. In certain representative embodiments, the NC process success release timer may expire and prompt (e.g., trigger) the release of the NC process used to decode the PDUs associated with the NC generation.

For example, a NC process success release timer may start when SDUs or SDU-segments of a NC generation are recovered following the decoding of the PDUs associated with the generation. The NC process success release timer may stop (e.g., upon expiry) and prompt the release of the NC process (e.g., NC context) for this NC generation.

In some representative embodiments, the receiving WTRU 102 may determine whether to associate a received PDU to a NC process based on any of the following: (i) whether the NC process success release timer is configured; (ii) whether the NC process success release timer is running; (iii) whether the NC process success release timer associated with the NC process is running; (iv) whether the NC process success release timer associated with the NC process is running, and the NC process is an active NC process; and/or (v) whether the NC process success release timer associated with the NC process is running, and the NC process is initiated for one or more PDU(s) with NC PDU set SN having a value equal to the value of the NC PDU set SN of the received PDU.

As an example, in response to the NC process success release timer (e.g., that is associated with the NC process) not running, and the NC process is initiated for one or more PDU(s) with a NC PDU set SN having a value equal to the value of the NC PDU set SN of the received PDU, the receiving WTRU 102 may associate the PDU to the NC process.

For example, a PDU may be associated with a NC process based on usage of a (e.g., configured) time duration. A receiving WTRU 102 may determine whether to associate a received PDU with a NC process or to discard the received PDU based on (e.g., at least) a first time duration (e.g., Duration_threshold) and a second time duration. The second time duration may be the time duration between the time (e.g., instant) of the successful decoding of the NC process and a time (e.g., instant) of the reception of the received PDU.

In some representative embodiments, a receiving WTRU 102 may determine whether to not associate a received PDU with a NC process and discard the received PDU based on (e.g., at least one) of the following: (i) whether the NC process has/had been successful decoded; and/or (ii) whether the second time duration is less than or equal to the first time duration (e.g., Duration_threshold).

For example, the second time duration may be a time difference between the WTRU 102 receiving the PDU and the NC process being successfully decoded.

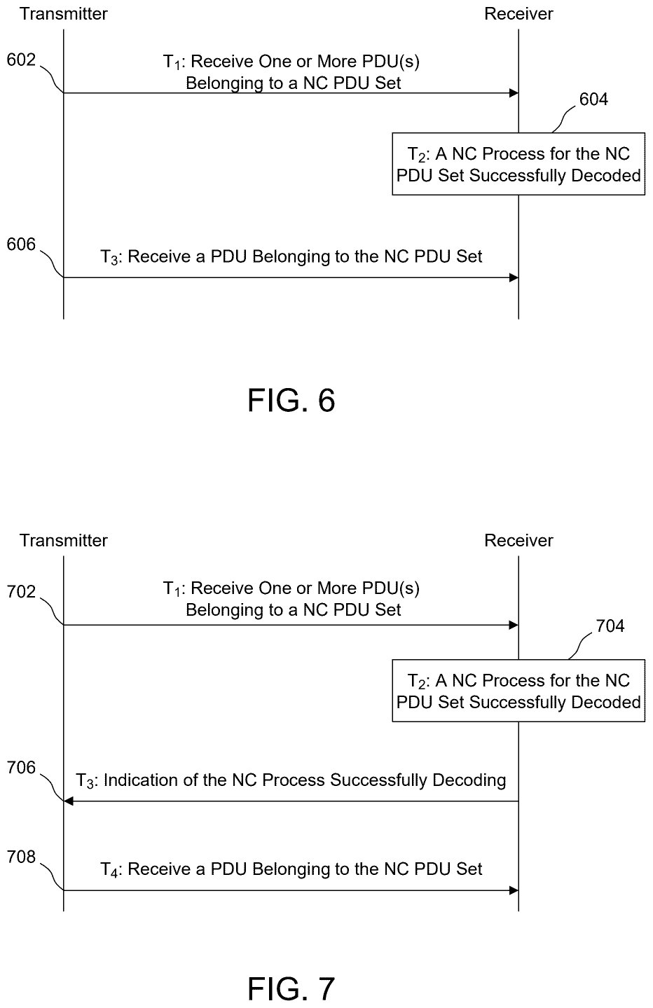

FIG. 6 is a timing diagram illustrating an example communication flow between a transmitter and a receiver. As shown in FIG. 6, a receiving WTRU 102 may receive, at 602, one or more PDUs belonging to a NC PDU set at a time T₁. The receiving WTRU 102 may determine, at 604, the NC process has been successfully decoded at a time T₂. The receiving WTRU 102 may receive, at 606, a PDU belonging to the NC PDU set at a time T₃.

It is noted that, due to a NC decoding process delay in WTRU 102 implementation, the time T₂ may occur at a timing later than the time T₁. In general, a timing at which the NC process of a NC PDU set is successfully decoded may be interpreted as the timing when the one or more PDU(s) are received (e.g., T₁), where the one or more PDU(s) belongs to the NC PDU set and the NC process successfully decoded based on at least one or more of the PDUs. That is, the reception of the one or more PDUs enables the NC process to be successfully decoded at T₂. In some representative embodiments, the second time duration may be defined as the time difference between times T₃ and T₂. In some representative embodiments, the second time duration may be defined as the time difference between times T₃ and T₁.

For example, the second time duration may be a time difference between the receiving WTRU 102 receives the PDU and the receiving WTRU 102 indicates transmitter (e.g., gNB) the NC process has been successfully decoded.

FIG. 7 is a timing diagram illustrating another example communication flow between a transmitter and a receiver;

As shown in FIG. 7, a receiving WTRU 102 may receive, at 702, one or more PDUs belonging to a NC PDU set at a time T₁. After the NC process for the NC PDU set is successfully decoded a 704, the receiving WTRU 102 may transmit an indication to the transmitter, at 706, to notify that the NC process was successfully decoded. That is, the receiving WTRU 102 receives one or more PDUs belonging to a NC PDU set at T₁. Assuming the NC process has been successfully decoded at T₂, the receiving WTRU 102 may indicate that the NC process successfully decoded to the transmitter at T₃. And the receiving WTRU 102 receives, at 708, a PDU belonging to the NC PDU set at T₄. In some representative embodiments, the second time duration may be the time difference between times T₄ and T₃.

For example, the second time duration may be a time difference between the receiving WTRU 102 receiving the PDU and the receiving WTRU 102 receiving an acknowledgement from the transmitter. The acknowledgement may indicate the reception of an indication of the successful decoding of the NC process that transmitted by the receiving WTRU 102.

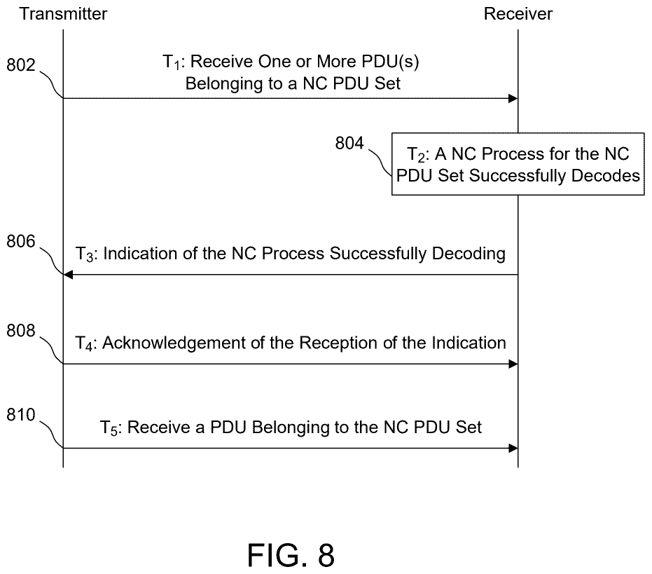

FIG. 8 is a timing diagram illustrating another example communication flow between a transmitter and a receiver. As shown in FIG. 8, a receiving WTRU 102 may receive, at 802, one or more PDUs belonging to a NC PDU set at a time T₁. After the NC process for the NC PDU set successfully decodes at 804, the receiving WTRU 102 may transmit, at 806, an indication to the transmitter to provide notification that the NC process successfully decoded. Then, the receiving WTRU 102 may expect to receive an acknowledgement of the reception of the indication from the transmitter at 808. That is, the receiving WTRU 102 may receive one or more PDUs belong to a NC PDU set at T₁. Assuming the NC process has been successful at T₂, the receiving WTRU 102 indicates the NC process successfully decoded to the transmitter at T₃. Then, the receiving WTRU 102 may receive an acknowledgment of the reception of the indication from the transmitter at T₄. And then, the receiving WTRU 102 receives, at 810, a PDU belonging to the NC PDU set at T₅. In some representative embodiments, the second time duration may be the time difference between T₅ and T₄.

In certain representative embodiments, in response to the receiving WTRU 102 determining that the second time duration is equal to or less than the threshold, the receiving WTRU 102 may determine not to associate the PDU to the NC process. That is, the receiving WTRU 102 may determine to discard the PDU.

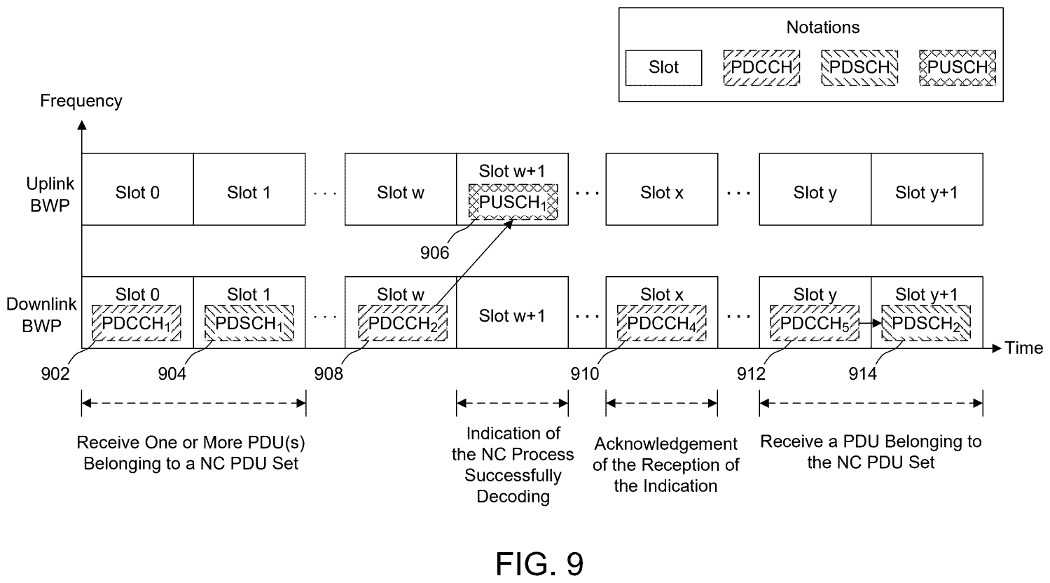

FIG. 9 is a scheduling diagram illustrating details of a communication flow between a transmitter and a receiver. As shown in FIG. 9, a receiving WTRU 102 may receive a DCI on PDCCH₁ (e.g., a first PDCCH transmission) 902 in a Slot #0 from the transmitter. The DCI may indicate (e.g., schedule) a PDSCH₁ (e.g., receiving a first PDSCH transmission) 904 in Slot #1. The PDSCH₁ 904 may carry the one or more PDUs belonging to a NC PDU set. The reception of the one or more PDUs via the PDSCH₁ 904 may enable the NC process to successfully decode. After the successful decoding, in Slot #w+1, the receiving WTRU 102 may transmit an indication on PUSCH₁ (e.g., a first PUSCH transmission) 906 to the transmitter to indicate the successful decoding. For example, the PUSCH₁ 906 may be either a configured grant or a dynamic grant scheduled by a PDCCH₂ (e.g., a second PDCCH transmission) 908 in slot #w. In slot #x, the receiving WTRU 102 may receive a PDCCH₄ (e.g., a third PDCCH transmission) 910 associated with a HARQ process which is the same as a HARQ process the PDCCH₂ 908 is associated with, and the PDCCH₄ 910 carries a DCI with an NDI bit which has been toggled. After, in Slot #y, the receiving WTRU 102 may receive a DCI on PDCCH₅ (e.g., a fourth PDCCH transmission) 912 from the transmitter, and the DCI indicates (e.g., schedules) a PDSCH₂ (e.g., receiving a second PDSCH transmission) 914 in Slot #y+1. The PDSCH₂ 914 may carry a PDU belonging to the NC PDU set.

In some representative embodiments, the timing at which a receiving WTRU 102 “receives one or more PDU(s) belong to a NC PDU set” may be defined as any of the following: (i) a slot, sub-slot, or subframe in which the receiving WTRU 102 receives a DCI (e.g., on a PDCCH) scheduling a PDSCH reception, and the PDSCH carries one or more PDU(s) belonging to the NC PDU set (e.g., the NC process successfully decodes by using at least the one or more PDUs), and/or (ii) a first symbol or a last symbol of a CORESET in which the receiving WTRU 102 receives a DCI on a PDCCH scheduling a PDSCH reception, and the PDSCH carries one or more PDUs belonging to the NC PDU set (e.g., the NC process successfully decodes by using at least the one or more PDUs). For example, this timing may refer to slot #0 in FIG. 9. For example, the timing may (e.g., further) refer to a first symbol or a last symbol of the PDCCH₁.

In some representative embodiments, the timing at which a “NC process for the NC PDU set successfully decodes” may be defined as the timing the NC process successfully decodes based on at least the one or more PDUs. For example, as shown in FIGS. 6-8, the reception of the one or more PDUs at T₁ enables the NC process to successfully decode at T₂.

In some representative embodiments, the timing for the “indication of the NC process successfully decoding” may be defined as any of the following: (i) a slot, sub-slot, or subframe in which the receiving WTRU 102 transmits the indication (e.g., on a PUSCH or PUCCH); (ii) a first symbol or last symbol of a (e.g., PUSCH, PUCCH) transmission carrying the indication; (iii) a symbol, slot, sub-slot, subframe in which the receiving WTRU 102 finished the last (e.g., latest) transmission carrying the indication (e.g., on a PUSCH or PUCCH in the case where uplink transmission repetition is configured).

For example, in FIG. 9, the timing may be referred to as Slot #w+1. For example, the timing may be referred to a first or last symbol of the PUSCH₁ in FIG. 9.

In some representative embodiments, the timing for the “acknowledgement of the reception of the indication” may be defined as any of the following: (i) a slot, sub-slot, or subframe in which the receiving WTRU 102 receives a DCI on a PDCCH, and the DCI has a NDI field indicating the PUSCH transmission (e.g., at T₃ in FIG. 8) has been received (e.g., ACK); and/or (ii) a first symbol or a last symbol of a CORESET in which the receiving WTRU 102 receives a DCI on a PDCCH, and the DCI has a NDI field indicating the PUSCH transmission (e.g., at T₃ of FIG. 8) has been received (e.g., ACK). For example, the indication of the NC process successfully being decoded may be transmitted on a PUSCH scheduled by a gNB associated with a HARQ process, and the acknowledgement of the reception of the indication may be interpreted as a DCI scheduling another PUSCH associated with the HARQ process, and the DCI having an NDI value toggled. In FIG. 9, this timing may be referred to as Slot #x. As another example, this timing may be referred to as a first symbol or a last symbol of PDCCH₄ in FIG. 9.

In some representative embodiments, the timing for the receiving WTRU 102 to “receive a PDU belonging to the NC PDU set” may be defined as any of the following: (i) a slot, sub-slot, or subframe in which the receiving WTRU 102 receives a DCI (e.g., on a PDCCH) scheduling a PDSCH reception, and the PDSCH carries a PDU belong to the NC PDU set; and/or (ii) a first symbol or a last symbol of a CORESET in which the receiving WTRU 102 receives a DCI on a PDCCH scheduling a PDSCH reception, and the PDSCH carries a PDU belonging to the NC PDU set. In FIG. 9, this timing may be referred to as Slot #y. As another example, this timing may be a first symbol or a last symbol of the PDCCH₅ in FIG. 9.

For example, a PDU may be associated with a NC process based on an indication. In some representative embodiments, the receiving WTRU 102 may determine whether or not to associate a PDU to a NC process based on one or more indicator(s) carried by the PDU. For example, an indicator may indicate information of whether a coefficient matrix has been changed; and/or whether the PDU belongs to a new NC PDU set.

In certain representative embodiments, a receiving WTRU 102 may start a NC process success release timer for a NC process if the NC process is complete. For example, a NC process success release timer may be associated with a (e.g., respective) NC process which is initiated for a NC PDU set. The NC process success release timer may be started at any of the following timings: (i) when (e.g., in response to) at least one SDU has been successfully decoded by the NC process; (ii) a SDU associated with the NC PDU set has been successfully decoded (e.g., when segmented-SDU based NC is configured); (iii) all SDUs (e.g., used to generate the NC PDU set) associated with the NC PDU set have been successfully decoded (e.g., when cross-SDUs based NC is configured); (iv) when the receiving WTRU 102 receives a PDU, and the PDU enables the NC process to successful decode; and/or (v) when the receiving WTRU 102 receives a DCI scheduling a PDSCH reception, and the PDSCH carries a PDU enabling the NC process to successfully decode.

For example, a NC process success release timer may be started at any of T₁, T₂, T₃ and/or T₄ in FIGS. 6-9. The receiving WTRU 102 may set an initial value of the NC process success release timer to the success release duration and then start the NC process success release timer at of T₁, T₂, T₃ and/or T₄ in FIGS. 6-9.

### Discarding a PDU

In certain representative embodiments, a receiving WTRU 102 may discard a received PDU, such as in response to not associating the received PDU with a NC process.

For example, a receiving WTRU 102 may receive a PDU belonging to a NC PDU set, and the receiving WTRU 102 may determines not to associate the PDU with a NC process of a NC PDU set, and the receiving WTRU 102 may discard the PDU. As an example, the receiving WTRU 102 may determine not to associate the PDU with the NC process in case the PDU has been received before.

For example, a receiving WTRU 102 may receive a PDU belonging to a NC PDU set, and the receiving WTRU 102 may determine not to associate the PDU with any (e.g., initialized) NC processes, and the receiving WTRU 102 may discard the PDU.

In certain representative embodiments, a receiving WTRU 102 may discard a received PDU, and send to a transmitting entity (e.g., another WTRU 102 or a gNB) information indicating that the PDU has been discarded.

For example, in response to (e.g., after) the receiving WTRU 102 discards a PDU belonging to a NC PDU set as mentioned above, the receiving WTRU 102 may indicate to a transmitter that the NC PDU has been discarded. As an example, a PDU discard indicator may be transmitted by the receiving WTRU 102 to the transmitter. The PDU discard indicator may include information indicating any of the following: (i) an order SN of the PDU; (ii) a NC PDU set SN of the PDU; (iii) a PDCP SN of a SDU associated with the NC PDU set; and/or (iv) a subset of PDCP SNs of a SDU associated with the NC PDU set.

For example, the PDU discard indicator may indicate which PDU(s) (e.g., at the PDCP layer) have been discarded.

For example, the format and the content of the PDU discard indicator may be, but is not limited to be, implemented as one or more of following.

For example, the PDU discard indicator may be or include a bitmap.

For example, the bitmap may have a number of bits equal to a maximum number of PDUs (e.g., that may be) generated for the NC PDU set (e.g., a maximum number of PDUs that may be generated by using a NC SDU set associated with the NC PDU set).

For example, each bit of the bitmap of the PDU discard indicator may be associated with a PDU of the NC PDU set.

For example, a position of a bit within the bitmap may indicate which PDU of the NC PDU set the bit is associated with. As an example, the 1st bit of the bitmap may be associated with a PDU of the NC PDU set having a smallest (or largest) value of the order SN, and the 2nd bit of the bitmap may be associated with the PDU of the NC PDU set having a second smallest (or largest) value of the order SN, and so on.

As an example, each bit of the bitmap of the PDU discard indicator may indicate a discard status of a PDU belonging to the NC PDU set. For example, a bit set to a first value may indicate that the corresponding PDU has been discarded by the receiving WTRU 102, and a bit set to a second value may indicate that the corresponding PDU has not been discarded by the receiving WTRU 102.

In certain representative embodiments, a PDU discard indication may be carried by a PDCP status report, and/or a NC-specific status report. For example, the NC-specific status report may include information indicating any of (i) a PDU receiving status; (ii) a SDU receiving status; (iii) a SDU decoding status; and/or (iv) a NC process decoding status.

In certain representative embodiments, after the receive WTRU 102 releases a NC process, the receiving WTRU 102 may transmit information indicating that the NC process has been released (e.g., discarded). For example, in response to the receiving WTRU 102 releasing a NC process as mentioned above, the receiving WTRU 102 may indicate to a transmitter (e.g., another WTRU 102 or gNB) that the NC process has been released. That is, a NC process release indicator may be transmitted by the receiving WTRU 102 to the transmitter. The NC process release indicator may information indicating any of an identification of the NC process, and/or a SN of the NC process.

For example, the format and the content of the NC process release indicator may be, but is not limited to be, implemented as one or more of following.

For example, the NC process release indicator may be or include a bitmap.

For example, the NC process release indicator may include a bitmap having a number of bits equal to a maximum number of NC processes that may be configured (e.g., executed) for any of a radio bearer, a PDCP entity, a serving cell, and/or a serving cell group (e.g., in parallel).

For example, each bit of the bitmap of the NC process release indicator may be associated with a NC process.

For example, a position of a bit within the bitmap may indicate which NC process the bit is associated with. As an example, the 1st bit of the bitmap may be associated with a NC process having a smallest (or largest) value of a NC process ID, and the 2nd bit of the bitmap may be associated with a NC process having a second smallest (or largest) value of the NC process ID, and so on.

For example, each bit of the bitmap of the NC process release indicator may indicate a discard status of a NC process. As an example, a bit set to a first value may indicate that the corresponding NC process has been discarded by the receiving WTRU 102, and a bit set to a second value may indicate that the corresponding NC process has not been discarded by the receiving WTRU 102.

In certain representative embodiments, a NC process release indicator may carried by any of a PDCP status report, and/or a NC-specific status report. For example, a NC-specific status report may include information indicating any of (i) a PDU receiving status; (ii) a SDU receiving status; (iii) a SDU decoding status; and/or (iv) a NC process decoding status.

In certain representative embodiments, a receiving WTRU 102 may provide receiving status information to the network, such as for assisting code rate adaptation.

In certain representative embodiments, a receiving WTRU 102 may provide receiving status information to the network after the NC decoding process is performed. The receiving status information may be provided to the transmitter (e.g., another WTRU 102 or gNB). For example, the receiving WTRU 102 may accumulate (e.g., count) the number of PDUs that have been discarded, and then provide the number to the transmitter (e.g., network). For example, the receiving WTRU 102 may accumulate (e.g., count) the number of PDUs that have been discarded in a time duration (e.g., configured interval), and then provide the number to the transmitter (e.g., network). Based on the receiving status information received from the receiver, the transmitter may adapt the code rate and/or adapt the coding coefficients accordingly.

In certain representative embodiments, the receiving status information may include information indicating any of following: (i) a number of PDUs discarded; (ii) a number of PDU discarded in a time duration; (iii) a number of PDUs associated with a NC process that are discarded; (iv) a number of PDUs associated with a number of NC processes that are discarded (e.g., the number of NC processes are associated with consecutive NC PDU set SNs); (v) a number of PDUs associated with a NC process that are discarded in a time duration; (vi) a number of PDUs associated with a radio bearer that are discarded; (vii) a number of PDUs associated with a radio bearer that are discarded in a time duration; (viii) a percentage of PDUs discarded; (ix) a percentage of PDUs that are discarded in a time duration; (x) a percentage of PDUs associated with a NC process that are discarded; (xi) a percentage of PDUs associated with a number of NC processes that are discarded (e.g., the number of NC processes are associated with consecutive NC PDU set SNs); (xii) a percentage of PDUs associated with a NC process that are discarded in a time duration; (xiii) a percentage of PDUs associated with a radio bearer that are discarded; (xiv) a percentage of PDUs associated with a radio bearer that are discarded in a time duration; (xv) a rate of NC processes decoded successfully; (xvi) a number of NC processes decoded successfully; (xvii) a number of NC processes decoded successfully in a time duration; (xviii) a number of NC processes decoded successfully in a span (e.g., the span is defined as a number of NC processes associated with consecutive NC PDU set SNs); (xix) a number of NC processes associated with a radio bearer decoded successfully; (xx) a number of NC processes associated with a radio bearer decoded successfully in a time duration; (xxi) a number of NC processes associated with a radio bearer decoded successfully in a span (e.g., the span is defined as a number of NC processes associated with consecutive NC PDU set SNs); (xxii) a percentage of NC processes decoded successfully; (xxiii) a percentage of NC processes decoded successfully in a time duration; (xxiv) a percentage of NC processes decoded successfully in a span (e.g., the span is defined as a number of NC processes associated with consecutive NC PDU set SNs); (xxv) a percentage of NC processes associated with a radio bearer decoded successfully; (xxvi) a percentage of NC processes associated with a radio bearer decoded successfully in a time duration; and/or (xxvii) a percentage of NC processes associated with a radio bearer decoded successfully in a span (e.g., the span is defined as a number of NC processes associated with consecutive NC PDU set SNs).

For example, the “time duration” mentioned above may be pre-configured, such as by the gNB via RRC signaling. For example, the time duration may be, but is not limited to be, defined as any of following: (i) a duration prior to the receiving status transmission; (ii) a duration prior to a specific NC process is initiated; (iii) a duration prior to a specific NC process decoding successfully; (iv) a duration prior to a specific NC process being released; and/or (v) a duration prior to a specific PDU being discarded.

For example, the “percentage of PDUs that are discarded” mentioned above may be, but is not limited to be, defined as number of PDU discarded over a number of PDU received.

For example, the “receiving status information” mentioned above may be implemented as follows. The receiving WTRU 102 may include a first indicator and a second indicator in the receiving status information. The first indicator may indicate a first NC PDU set SN. The second indicator may indicate which NC process(es) decoded successfully among multiple NC processes. The multiple processes may be the NC processes associated with NC PDU set SNs which belong to a range (e.g., span). For example, the range may be defined as a first NC PDU set SN-X to a first NC PDU set SN, where X may be pre-defined or be indicated by the receiving WTRU 102 within the receiving status information.

For example, the “receiving status information” mentioned above may be implemented as follows. The receiving WTRU 102 may include a first indicator and a second indicator in the receiving status information. The first indicator may indicate a first NC PDU set SN. The second indicator may indicate a percentage of NC processes decoded successfully among consecutive NC processes. The consecutive NC process(es) are the NC process(es) which are associated with a NC PDU set SN within an interval. For example, the interval may be from a first NC PDU set SN-X to a first NC PDU set SN, where X may be pre-defined or be indicated by the receiving WTRU 102 within the receiving status information.

In certain representative embodiments, the receiving status information may include information indicating any of the following: (i) a number of PDUs discarded is equal to or higher (or lower) than a specific threshold; (ii) a number of PDUs be discarded in a time duration is equal to or higher (or lower) than a specific threshold; (iii) a number of PDUs associated with a NC process that are discarded is equal to or higher (or lower) than a specific threshold; (iv) a number of PDUs associated with a number of NC processes that are discarded is equal to or higher (or lower) than a specific threshold (e.g., the number of NC processes are associated with consecutive NC PDU set SNs); (v) a number of PDUs associated with a NC process that are discarded in a time duration is equal to or higher (or lower) than a specific threshold; (vi) a number of PDUs associated with a radio bearer that are discarded is equal to or higher (or lower) than a specific threshold; (vii) a number of PDUs associated with a radio bearer that are discarded in a time duration is equal to or higher (or lower) than a specific threshold; (viii) a percentage of PDUs that are discarded is equal to or higher (or lower) than a specific threshold; (ix) a percentage of PDUs that are discarded in a time duration is equal to or higher (or lower) than a specific threshold; (x) a percentage of PDUs associated with a NC process that are discarded is equal to or higher (or lower) than a specific threshold; (xi) a percentage of PDUs associated with a number of NC processes that are discarded is equal to or higher (or lower) than a specific threshold (e.g., the number of NC processes are associated with consecutive NC PDU set SNs); (xii) a percentage of PDUs associated with a NC process that are discarded in a time duration is equal to or higher (or lower) than a specific threshold; (xiii) a percentage of PDUs associated with a radio bearer that are discarded is equal to or higher (or lower) than a specific threshold; (xiv) a percentage of PDUs associated with a radio bearer that are discarded in a time duration is equal to or higher (or lower) than a specific threshold; (xv) a NC process decoding success rate is equal to or higher (or lower) than a specific threshold; (xvi) a number of NC processes decoded successfully is equal to or higher (or lower) than a specific threshold; (xvii) a number of NC processes decoded successfully in a time duration is equal to or higher (or lower) than a specific threshold; (xviii) a number of NC processes decoded successfully in a span is equal to or higher (or lower) than a specific threshold (e.g., the span is defined as a number of NC processes associated with consecutive NC PDU set SNs); (xix) a number of NC processes associated with a radio bearer decoded successfully is equal to or higher (or lower) than a specific threshold; (xx) a number of NC processes associated with a radio bearer decoded successfully in a time duration is equal to or higher (or lower) than a specific threshold; (xxi) a number of NC processes associated with a radio bearer decoded successfully in a span is equal to or higher (or lower) than a specific threshold (e.g., the span is defined as a number of NC processes associated with consecutive NC PDU set SNs); (xxii) a percentage of NC processes decoded successfully is equal to or higher (or lower) than a specific threshold; (xxiii) a percentage of NC processes decoded successfully in a time duration is equal to or higher (or lower) than a specific threshold; (xxiv) a percentage of NC processes decoded successfully in a span is equal to or higher (or lower) than a specific threshold (e.g., the span is defined as a number of NC processes associated with consecutive NC PDU set SNs); (xxv) a percentage of NC processes associated with a radio bearer decoded successfully is equal to or higher (or lower) than a specific threshold; (xxvi) a percentage of NC processes associated with a radio bearer decoded successfully in a time duration is equal to or higher (or lower) than a specific threshold; and/or (xxvii) a percentage of NC processes associated with a radio bearer decoded successfully in a span is equal to or higher (or lower) than a specific threshold (e.g., the span is defined as a number of NC processes associated with consecutive NC PDU set SNs).

For example, the “specific threshold” mentioned above may be, but is not limited to be, either pre-configured by the network through RRC signaling or pre-defined in a technical specification.

In certain representative embodiments, the receiver may deliver the receiving status information via any of PDCP signaling, MAC CE and/or physical layer signaling.

### NC Process Management

In certain representative embodiments, a receiver may start a NC process stuck timer associated with a NC process when the NC process is initiated.

In certain representative embodiments, once a configured NC process is activated at a transmitter, multiple PDUs may be generated by using a NC SDU set. The multiple PDUs may belong to a NC PDU set. The multiple PDUs may be transmitted by the transmitter to the receiving WTRU 102 individually (e.g., through different signaling or transmissions). From the receiving WTRU 102 perspective, based on the features described herein, a NC process for the NC PDU set may be initiated by the receiving WTRU 102 in response to the receiving WTRU 102 receiving any of the multiple PDUs.

In certain representative embodiments, once a NC process for a NC PDU set is initiated, the receiving WTRU 102 may store all received PDUs belonging to the NC PDU set to support the decoding by the NC process until the NC process is released. For example, the received PDUs may be, but are not limited to being, stored in memory 130 and/or 132 of the WTRU 102.

In certain representative embodiments, once the NC process is initiated, the NC process may be treated as an active NC process until it is released. The receiving WTRU 102 may set an initial value of a NC process stuck timer to the stuck duration and the WTRU 102 may start the NC process stuck timer for the NC process when the NC process is initiated.

For example, the receiving WTRU 102 may maintain a NC process stuck timer for each initiated NC process. That is, for each initiated NC process, the receiving WTRU 102 may start a respective NC process stuck timer for each initiated NC process. That is, for each initiated NC process, the receiving WTRU 102 may set an initial value of a NC process stuck timer to the stuck duration and the receiving WTRU 102 may start the NC process stuck timer.

For example, the receiving WTRU 102 may maintain a NC process stuck timer (e.g., only) for a specific type(s) of NC process(es). The specific type of NC process may include, but is not limited to, any of: (i) a NC process associated with a specific radio bearer (e.g., SRB, DRB) indicated by the gNB 180; (ii) a NC process associated with a radio bearer configured with specific QoS requirements; (iii) a NC process associated with a NC PDU set indicated by the gNB 180; (iv) a NC process associated with a NC PDU set with a NC PDU set SN within a specific range which is configured by the gNB (e.g., NC_PDU_set_SN_range); and/or (v) a NC process associated with a NC PDU set which is generated by the transmitter by applying one or more specific NC coefficient matrices.

In certain representative embodiments, a receiving WTRU 102 starts a NC process stuck timer for a NC process when the NC process is initiated.

In certain representative embodiments, a receiving WTRU 102 starts a respective NC process stuck timer for a NC process in response to the NC process being initiated.

In certain representative embodiments, a receiving WTRU 102 may restart a NC process stuck timer for a NC process associated with a NC PDU set. For example, the NC process stuck timer may be restarted when the receiving WTRU 102 receives a PDU belonging to the NC PDU set and the NC process stuck timer of the NC process is running.

In certain representative embodiments, once a NC process of a NC PDU set is initiated, a NC process stuck timer may be started, and the NC process may be treated as an active NC process until it is released. In case a NC process is kept active and the NC process stuck timer is running, the receiving WTRU 102 may restart the NC process stuck timer in response to receiving a PDU belonging to the NC PDU set. That is, the NC process stuck timer may be restarted in each time the receiving WTRU 102 receives a PDU belonging to the NC PDU set and the NC process has not yet been released.

In certain representative embodiments, a receiving WTRU 102 may release a NC process (e.g., based on a timer expiry and/or an explicit indication).

In certain representative embodiments, a receiving WTRU 102 may determine to release a NC process based on a NC process success release timer associated with the NC process and a NC process stuck timer associated with the NC process.

For example, the receiving WTRU 102 may determine either a NC process success release timer or a NC process stuck timer (e.g., associated with a NC PDU set) has expired. In response to either the NC process success release timer or the NC process stuck timer expiring, the receiving WTRU 102 may perform a NC process release procedure.

For example, the NC process release procedure may include any of the following: (i) releasing the NC context associated with the NC process; (ii) clearing a buffer storing the received PDUs associated with the NC process; (iii) discarding all stored PDUs associated with the NC process; (iv) stopping either the NC process release timer or the NC process stuck timer (e.g., the non-expired timer); and/or (v) sending an indication to the transmitter that the NC process is released.

In certain representative embodiments, a receiving WTRU 102 may release a NC process in response to receiving an indication transmitted by the transmitter.

In certain representative embodiments, management of a NC context may be performed.

In certain representative embodiments, a receiving WTRU 102 may associate coding coefficient(s) of a PDU to a NC context of a NC process based on a coefficient matrix indicator and/or a coefficient vector indicator carried by the PDU.

In certain representative embodiments, a receiving WTRU 102 may be configured (e.g., by a transmitter, such as a gNB 180 using RRC messaging) with one or more coefficient matrices. For example, the receiving WTRU 102 may be configured with at least one default coefficient matrix. For example, each (e.g., subset of) coefficient matrices may be associated with a coefficient matrix index. For example, each coefficient matrix may contain a different number of rows, and each row may be represented as a coefficient vector. For example, each row may include a plurality of coding coefficients.

In certain representative embodiments, a received PDU may include information indicating (e.g., in a PDCP sub-header) any of the following: (i) a coefficient matrix indicator; and/or (ii) a coefficient vector indicator.

For example, the coefficient matrix indicator may be represented as a coefficient index. The coefficient index may indicate a coefficient matrix, within the at least one coefficient matrices, applied to generate the first PDU; and/or a subset of a coefficient matrix, within the at least one coefficient matrices, applied to generate the first PDU. For example, a coefficient matrix indicator may not be carried by the PDU (e.g., implicitly indicating that a default coefficient matrix is applied).

For example, the coefficient vector indicator may indicate one or more rows, within the (e.g., subset of) coefficient matrix, applied to generate the first PDU.

For each received PDU, the receiving WTRU 102 may associate the indicated one or more coding coefficient(s) to an associated (e.g., existing) NC process, and store the one or more coding coefficient(s) into a NC context of the NC process.

In certain representative embodiments, a SDU may be determined to be discarded.

In certain representative embodiments, a transmitter may determine to discard a SDU of a NC SDU set if all SDUs of the NC SDU set have been indicated as successfully received (e.g., by a receiving WTRU 102).

In certain representative embodiments, once a NC process is configured and activated at a transmitter, multiple PDUs may be generated by using a NC SDU set which contains multiple SDUs. It is assumed that the receiving WTRU 102 may indicate to the transmitter (e.g., transmitting WTRU 102 or gNB 180) information regarding the SDU receiving status. For example, the SDU receiving status may be indicated via a (e.g., legacy) PDCP status report. That is, the receiving WTRU 102 may indicate which SDU(s) are missing and which SDU(s) are received successfully based on a PDCP status report transmission.

In some representative embodiments, cross-SDUs based NC may be configured, and multiple SDUs belonging to a NC SDU set may be applied by the transmitter to generate the multiple PDUs. In response to receiving a PDCP status report indicating at least one of the multiple SDUs has been received successfully, the transmitter may determine to discard the at least one SDU if all other SDU belonging to the NC SDU set have been indicated as successfully received by the receiver. For example, the transmitter may determine to discard a SDU belonging to a NC SDU set (e.g., only) when all SDUs belonging to the NC SDU set are indicated as successfully received by the receiver.

### COUNT Management

In certain representative embodiments, a COUNT value may be determined for a received PDU.

In certain representative embodiments, a receiving WTRU 102 may determine a COUNT value of a received PDU when the received PDU is indicated by an associated NC protocol as a successfully decoded PDU.

In certain representative embodiments, once a configured NC process is activated at a transmitter, multiple PDUs may be generated by using a NC SDU set and corresponding coding coefficients. The multiple PDUs may belong to a NC PDU set, but the multiple PDUs may be transmitted by the transmitter to the receiving WTRU 102 individually. From the perspective of the receiving WTRU 102, based on the features described herein, a NC process for the NC PDU set may be initiated by the receiving WTRU 102 in response to the receiving WTRU 102 receiving any of the multiple PDUs.

The receiving WTRU 102 may start to determine a COUNT value of a received PDU after the PDU is successfully decoded by the NC process.

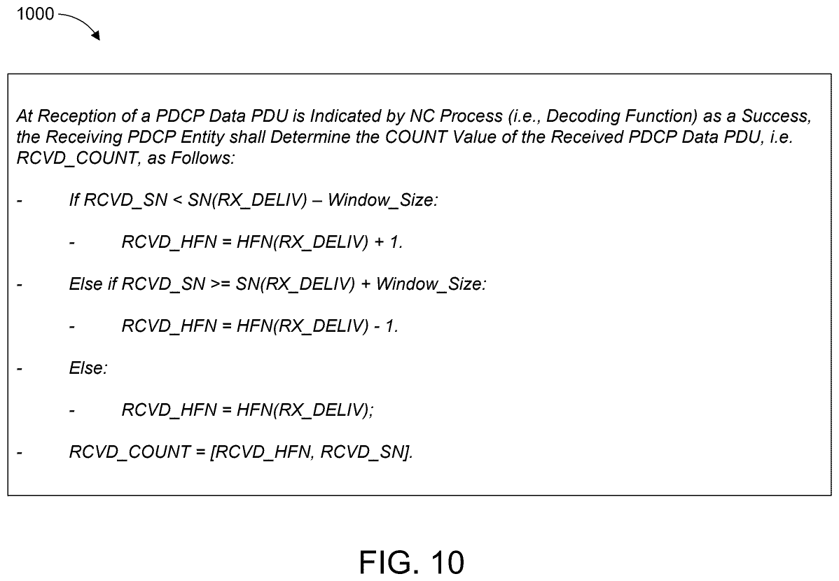

FIG. 10 is an algorithm diagram illustrating an example of determining a COUNT value. In the example 1000 of FIG. 10, the COUNT value is shown as RCVD_COUNT. For example, RX_DELIV may be a state variable that indicates the COUNT value of the first PDCP SDU not delivered to the upper layers, but still waited for. For example, Window_Size may be a constant that indicates a size of a reordering window.

In FIG. 10, HFN (State Variable) may indicate the HFN part (e.g., the number of most significant bits equal to an HFN length) of the State Variable (e.g., RX_DELIV). SN (State Variable) may indicate the SN part (e.g., the number of least significant bits equal to a PDCP SN length) of the State Variable. RCVD_SN may indicate the PDCP SN of a received PDCP Data PDU included in the PDU header. RCVD_HFN may indicate the HFN of the received PDCP Data PDU calculated by the receiving PDCP entity. As shown in FIG. 10, RCVD_COUNT may indicate the COUNT of the received PDCP Data PDU as [RCVD_HFN, RCVD_SN].

### Example Procedures

In certain representative embodiments, a NC protocol may be implemented (e.g., executed) by a receiver (e.g., a WTRU 102). For example, the NC protocol may be implemented by a receiving PDCP entity of the receiver.

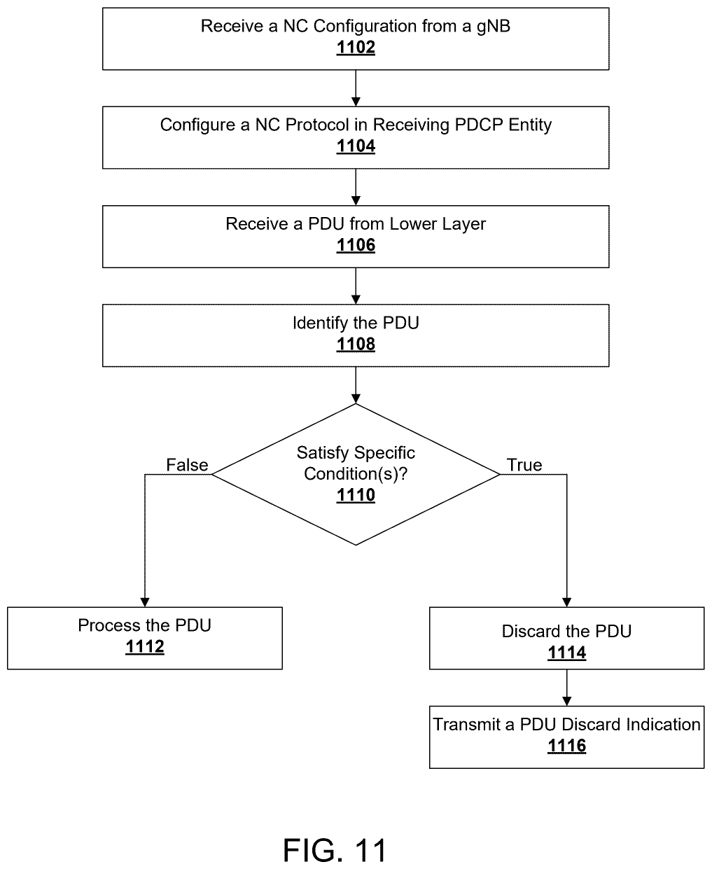

FIG. 11 is a procedural diagram illustrating an example PDU processing flow. In FIG. 11, a receiver (e.g., a WTRU 102) may receive a NC configuration from a transmitter (e.g., a gNB 180) at 1102. For example, the receiving WTRU 102 may receive the NC configuration via a downlink RRC message. In certain representative embodiments, the NC configuration provided as or included in a radio bearer and/or a PDCP specific configuration. As an example, for different PDCP entities and/or radio bearers respectively configured with a NC protocol, the gNB 180 may provide individual NC configurations for each of the configured NC protocols. At 1104, a transmitter (e.g., another WTRU 102 or gNB 180) may configure a NC protocol (e.g., in a transmitting PDCP entity) based on (e.g., corresponding to) the NC configuration of the receiver. In certain representative embodiments, the NC protocol may be configured as a segmented SDU based NC or cross-SDUs based NC.

At 1106, the receiver may receive a PDU (e.g., sent by the transmitter) from a lower layer. At 1108, the receiver may identify the PDU based on any of a NC PDU set SN of the PDU and/or an order SN of the PDU. At 1110, the receiver may determine whether one or more (e.g., specific) conditions are satisfied. For example, the receiver may proceed to process the PDU at 1112 based on the one or more conditions not being satisfied. For example, the receiver may proceed to discard the PDU at 1114 based on the one or more conditions being satisfied.

In certain representative embodiments, the one or more conditions may be based on a NC process success release timer and/or a state of a NC process. For example, the receiver may determine whether a NC process success release timer of a NC process (e.g., associated with the NC PDU set SN to which the received PDU belongs) is running. Examples of when the NC process success release timer is started are described elsewhere herein. For example, the receiver may determine whether a NC process, of (e.g., associated with) a NC PDU set to which the received PDU belongs, has been successfully decoded.

For example, at 1110, the receiver may proceed to discard the PDU at 1114 based on any of: determining that the NC process success release timer is running, determining that the NC process has been successfully decoded, and/or the PDU received at 1106 is a duplicate PDU (e.g., based on PDU set SN and/or order SN). In some representative embodiments, the receiver may (e.g., also) transmit at 1116 a PDU discard indication (e.g., information indicating that the PDU has been discarded at 1114).

For example, at 1110, the receiver may proceed to process the PDU at 1112 based on any of determining that the NC process success release timer is not running and/or determining that the NC process has not been successfully decoded. In certain representative embodiments, the processing of the PDU at 1112 may include any of the following: (i) associating the received PDU to a NC process; (ii) identifying a coefficient matrix based on information (e.g., a coefficient matrix indicator) carried by the received PDU; (iii) identifying one of more coefficient vectors based on information (e.g., a coefficient vector indicator) carried by the received PDU; and/or (iv) associating the coding coefficients (e.g., identified based on the coefficient matrix and/or the coefficient vector indicator) to a NC context of the NC process.

In certain representative embodiments, a receiver (e.g., a receiving WTRU 102) may release a NC process (e.g., associated with a NC PDU set) in response to the NC process being decoded successfully. For example, the NC process may be associated with a NC PDU set, and the NC PDU set may be associated with (e.g., identified by) a NC PDU set SN. In some representative embodiments, the receiver may delay the NC process after the NC process has decoded successfully. For example, a NC process success release timer may be triggered (e.g., started) in response to the NC process decoding successfully. Then, the NC process may be released in response to the NC process success release timer having expired.

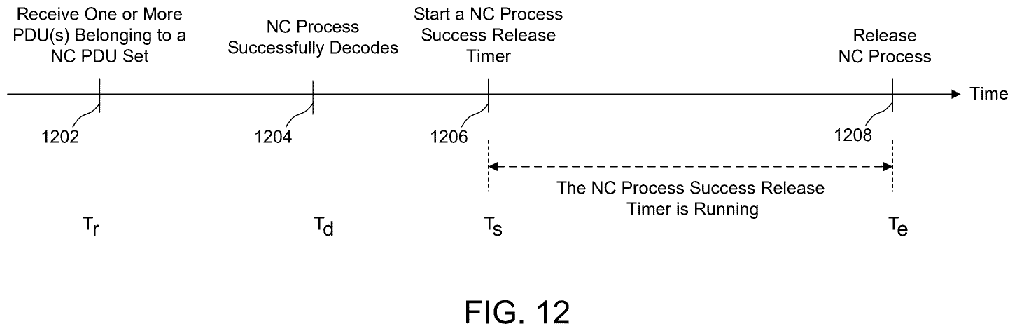

FIG. 12 is a timing diagram illustrating an example usage of a NC process success release timer. As shown in FIG. 12, a receiver (e.g., a receiving WTRU 102) may maintain a NC process success release timer for the NC process. For example, after one or more PDUs belonging to a NC PDU set are received, at 1202, at a time Tr, the NC process may decode successfully, at 1204, at a time T_{d} (e.g., using the one or more received PDUs). The receiver may start, at 1206, a NC process success release timer for the NC process at a time Tₛ. The receiver may release the NC process after the NC process release timer expires, at 1208, at a time Tₑ. Any PDUs belonging the NC PDU set that are received between (e.g., during) the time Tₛ and the time Tₑ may be discarded by the receiver. For example, any PDU with a NC PDU set SN that is associated with the NC PDU set which is received between Tₛ and Tₑ may be discarded by the receiver.

For example, a PDU with a NC PDU set SN associated with the NC PDU set may be received after the time Tₑ (e.g., after release of the NC process associated with the NC PDU set). In some representative embodiments, the receiving WTRU 102 may initiate a (e.g., new) NC process for this received PDU (e.g., NC PDU set). In some representative embodiments, the receiving WTRU 102 may not associate the PDU with the NC PDU set SN associated with the NC PDU set received after the time Tₑ with a (e.g., new) NC process and may discard the PDU.

In FIG. 12, the position of Tₛ is provided as an example. In other examples, the time Tₛ may be different, such as the time Tₛ may occur at a same or similar timing as the time Tr or the time T_{d}.

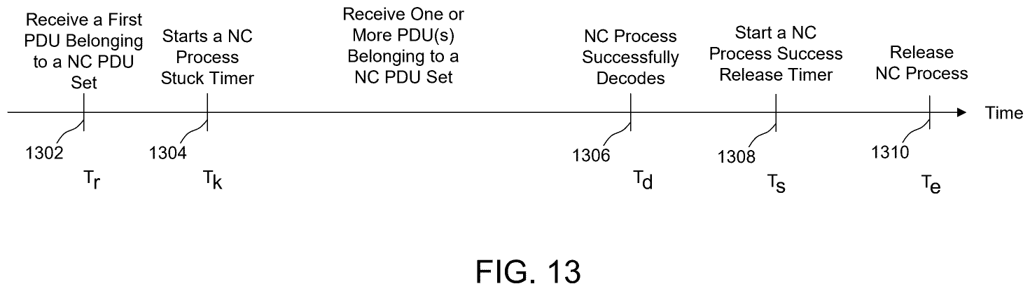

FIG. 13 is a timing diagram illustrating an example usage of a NC process stuck timer and a NC process success release timer.

As shown in FIG. 13, a receiver (e.g., a receiving WTRU 102) may receive, at 1302, a first PDU belonging to a NC PDU set at a time Tr.

In certain representative embodiments, the receiver may initiate a NC process for the first PDU at the time Tr. The receiver may start, at 1304, a NC process stuck timer for a NC process at a time Tk (e.g., after the NC process is initiated at Tr). For example, the NC process may be initiated in response to a first NC PDU belonging to the NC PDU set being received. After receiving one or more (e.g., other) PDUs belonging to the NC PDU set after the time Tk, the NC process may, at 1306, decode successfully at a time Ta by using any of the one or more PDUs. The receiver may restart the NC process stuck timer for the NC process each time a PDU belonging to the NC PDU set is received (e.g., and the NC process stuck timer has not expired). The receiver may start, at 1308, a NC process success release timer for the NC process at a time Tₛ. The receiver may release, at 1310, the NC process after the NC process success release timer expires at a later time Tₑ. For example, any other PDUs belonging the NC PDU set which are received between (e.g., during) the time Tₛ and the time Tₑ may be discarded by the receiver (e.g., the receiving WTRU 102). For example, any PDU with a NC PDU set SN associated with the NC PDU set that is received between Tₛ and Tₑ may be discarded.

In certain representative embodiments, a receiver (e.g., a receiving WTRU 102) may maintain a NC process stuck timer and a NC process success release timer as follows.

A receiving WTRU 102 may receive (e.g., from a transmitter, such as a gNB 180 using RRC messaging) information indicating a NC configuration. For example, the NC configuration may include (e.g., at least) information indicating a stuck duration and a success release duration.

The receiving WTRU 102 may receive a first PDU (e.g., from the gNB 180) that includes information (e.g., in a PDCP sub-header) indicating a first NC PDU set SN and a first order SN.

The receiving WTRU 102 may determine to associate the first PDU to a NC process based on at least the first NC PDU set SN and the first order SN. The receiving WTRU 102 may perform NC decoding using the NC process. In response to a SDU having been recovered by the NC process, the receiving WTRU 102 may set an initial value of (e.g., initialize) a NC process success release timer to the success release duration and start the NC process success release timer (e.g., which is associated with the NC process).

In certain representative embodiments, the receiving WTRU 102 may determine to associate the first PDU with a NC process based on any of the following.

For example, if the first NC PDU set SN is equal to a second NC PDU set SN of a second PDU, and a NC process stuck timer is running for an NC process associated with the second NC PDU set (e.g., at least one second PDU with a second NC PDU set SN has been received before, and the first NC PDU set SN is equal to the second NC PDU set SN), and if a NC process success release timer for the existing NC process associated with the second PDU is running (e.g., a SDU associated with the second PDU has been decoded successfully but the WTRU 102 has delayed the NC process release), the receiving WTRU 102 may discard the first PDU. Else (e.g., a SDU associated with the second PDU has not been decoded successfully), if the first order SN is different than the order SNs of all of other second PDUs (e.g., a same NC PDU set but different order SNs), the receiving WTRU 102 may associate the first PDU to the existing NC process (e.g., identified by or associated with the first NC PDU set SN), perform NC decoding by the existing NC process associated with the first PDU. If the first order SN is equal to the second order SN of the second PDU (e.g., the same NC PDU set and the same order SN), the receiving WTRU 102 may discard the first PDU.

For example, if no PDUs, with a NC PDU set SN equal to the first NC PDU set SN, has been previously received, and a NC process success release timer associated with the NC PDU set SN is not running, the receiving WTRU 102 may create and/or a (e.g., new) NC process for the NC PDU set indicated by the first NC PDU set SN, associate the first PDU to the (e.g., newly) initiated NC process, perform NC decoding by the NC process associated with the first PDU, and set an initial value of a NC process stuck timer to the stuck time duration and start a NC process stuck timer for the NC process (e.g., to avoid the first PDU being the only PDU of the NC PDU set which is received).

For example, if a SDU has been decoded successfully (e.g., by the NC process) and the NC process success release timer is running, the receiving WTRU 102 may discard the first PDU.

For example, if either the NC process success release timer or the NC process stuck timer for the NC process has expired, the receiving WTRU 102 may discard all PDUs associated with (e.g., stored for) the NC process and release the NC process.

In certain representative embodiments, a receiver (e.g., receiving WTRU 102) may receive a NC configuration from a transmitter (e.g., a gNB 180). The receiver may implement a NC protocol (e.g., at a PDCP entity) according to the received NC configuration. For example, the NC configuration may include (e.g., at least) information indicating a stuck duration and a success release duration. The NC process success release timer may be initialized based on the success release duration and the NC process stuck timer may be initialized based on the stuck duration.

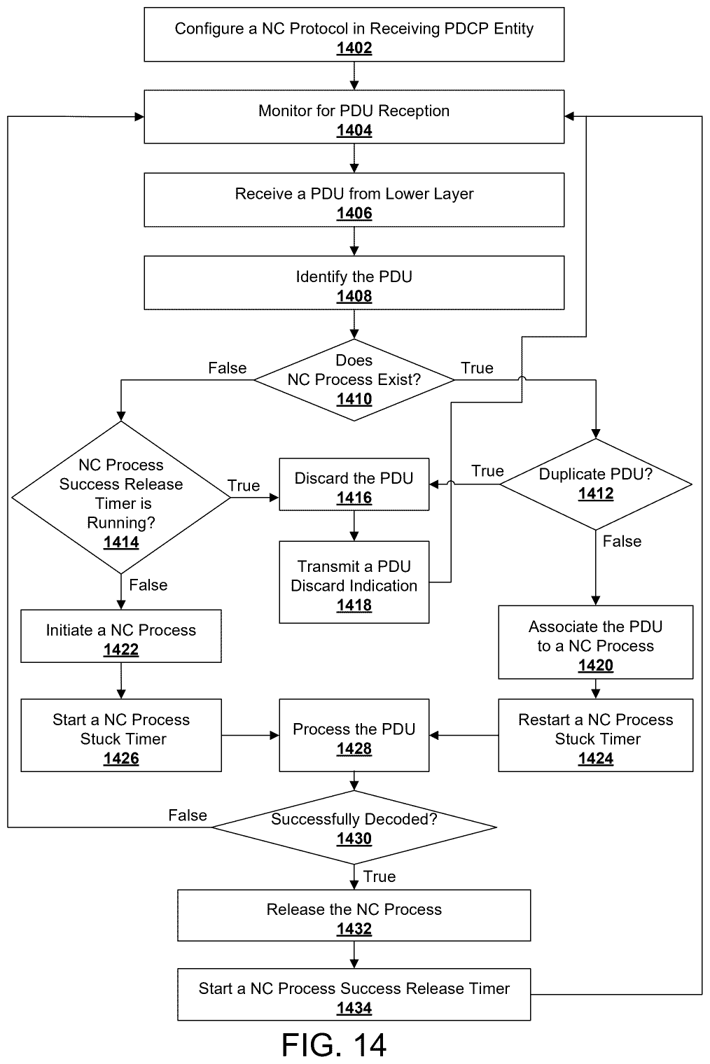

FIG. 14 is a procedural diagram illustrating an example NC flow at a receiver (e.g., receiving WTRU 102). As shown in FIG. 14, a receiving WTRU 102 may receive a NC configuration at 1402 (e.g., from a gNB 180). The NC configuration may be, but is not limited to being, carried by a downlink RRC message. Examples of NC configurations are described elsewhere herein. For example, the NC configuration may be a radio bearer and/or a PDCP-specific configuration. That is, for different PDCP entities and/or radio bearers configured with a (e.g., respective) NC protocol, individual NC configurations for each of the configured NC protocols.

For example, the transmitter (e.g., a transmitting WTRU 102 or gNB 180) may (e.g., also) configures a NC protocol (e.g., in a transmitting PDCP entity) based on the NC configuration. As examples, the NC protocol may be either configured as a segmented SDU based NC or cross-SDUs based NC.

At 1404, the receiving WTRU 102 may monitor for PDU reception. For example, the receiving WTRU 102 may monitor for a PDCCH transmission which includes scheduling information for a PDSCH scheduling. The receiving WTRU 102 may receive a scheduled PDSCH transmission.

At 1406, the receiving WTRU 102 may receive a (e.g., one or more) PDUs from a lower layer (e.g., carried by the PDSCH transmission). The PDU may belong to a NC PDU set.

At 1408, the receiving WTRU 102 may identify the PDU (e.g., as belonging to a NC PDU set). For example, the PDU may be identified based on at least information indicating any of a NC PDU set SN of the PDU and/or an order SN of the PDU.

At 1410, the receiving WTRU 102 may determine whether there is an active NC process for the NC PDU set. For example, if there is an active NC process that is initiated for the NC PDU set, the receiving WTRU 102 may proceed to 1412. Otherwise, the receiving WTRU 102 may proceed to 1414.

At 1412, the receiving WTRU 102 may determine whether the PDU has been received before (e.g., the PDU is a duplicated PDU) based on the NC PDU set SN of the PDU and an order SN of the PDU. For example, there may be a second PDU which has been received previously, and the second PDU is associated with the NC PDU set (e.g., NC process). The second PDU has a same order SN and NC PDU set SN as the received PDU. If the received PDU is a duplicate PDU, the receiving WTRU 102 may proceed to 1416. Otherwise, the receiving WTRU 102 may proceed to 1420.

At 1414, the receiving WTRU 102 may determine whether a NC process release timer associated with the NC PDU set is running. If the NC process release timer is running, the receiving WTRU 102 may proceed to 1422. Otherwise, the receiving WTRU 102 may proceed to 1420. For example, the NC process release timer may be started for the NC process when the NC process is released due to successful decoding. The NC process release timer running for a NC process may imply that the NC process has been successfully decoded not too long time ago (e.g., not earlier than the duration of the NC process success release timer). From the NC decoding perspective, the PDU may not be needed anymore, and it may be beneficial to discard the PDU to save memory. At 1416, the receiving WTRU 102 may discard the PDU.

At 1418, the receiving WTRU 102 may transmit information indicating the has been PDU discarded (e.g., a PDU discard indication) to the transmitter.

At 1420, the receiving WTRU 102 may associate the PDU with a (e.g., existing) NC process.

At 1422, the receiving WTRU 102 may initiate a (e.g., new) NC process for the PDU. For example, the receiving WTRU 102 may initiate a NC process for a NC PDU set to which the PDU belongs. The initiated NC process may be used to perform NC decoding of the NC PDU set.

At 1424, the receiving WTRU 102 may restart a NC process stuck timer of the NC process. That is, the receiving WTRU 102 may set an initial value of a NC process stuck timer to the NC process stuck duration and then start the NC process stuck timer.

At 1426, the receiving WTRU 102 start a NC process stuck timer of the NC process. That is, the receiving WTRU 102 may set an initial value of a NC process stuck timer to the NC process stuck duration and then start the NC process success release timer.

For example, the receiving WTRU 102 may maintain the NC process stuck timer for a NC process to avoid a NC process being initiated by a PDU reception, but unable to successfully decode for a long time (e.g., due to a lack of sufficient PDUs being received). In such situations, the NC process may occupy the memory for a long time.

At 1428, the receiving WTRU 102 may process the PDU. In certain representative embodiments, processing of the PDU may include any of the following: (i) associating the PDU to a NC process; (ii) identifying a coefficient matrix based on a coefficient matrix indicator carried by the PDU; (iii) identifying one of more coefficient vector(s) based on a coefficient vector indicator carried by the PDU; (iv) associating the coding coefficients, identified based on the coefficient matrix and/or the coefficient vector indicator, to a NC context of the NC process; and/or (iv) performing NC decoding, such as by using one or more of received PDUs belonging to the NC process and the coding coefficients.

At 1430, the receiving WTRU 102 may determine whether the NC process has been successfully decoded (e.g., X SDUs are obtained from decoding at least X received PDUs out of Y PDUs of the NC PDU set) based on a result from 1428. If the NC process has successfully decoded, the receiving WTRU 102 may proceed to 1432. Otherwise, the receiving WTRU 102 may proceed to 1404.

At 1432, the receiving WTRU 102 may release the NC process. For example, to release a NC process of a NC PDU set, the receiving WTRU 102 may discard all received and/or stored PDUs belonging to the NC PDU set.

At 1434, the receiving WTRU 102 may start a NC process success release timer for the NC PDU set. For example, the receiving WTRU 102 may set an initial value of a NC process success release timer to the success release duration and then start the NC process success release timer. The NC process success release timer may be used to avoid a late reception of a PDU from triggering the initiation of a NC process for the NC PDU set (e.g., associated with the late received PDU).

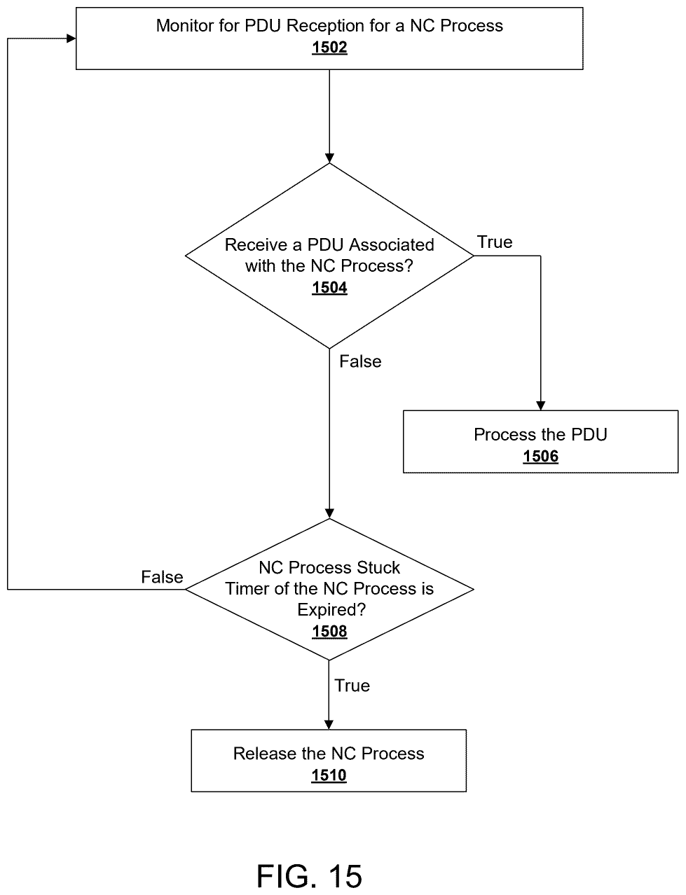

FIG. 15 is a procedural diagram illustrating an example NC process release flow using a NC process stuck timer. In certain representative embodiments, after a NC process is triggered (e.g., initiated) and a NC process stuck timer associated with the NC process is running, a receiving WTRU 102 may monitor for reception of one or more PDUs associated with the NC process.

As shown at 1502 in FIG. 15, a receiving WTRU 102 may monitor for PDU reception for a NC process which has a NC process stuck timer that is running.

At 1504, the receiving WTRU 102 may determine whether a PDU associated with the NC process is received. If a PDU associated with the NC process is received, the receiving WTRU 102 may proceed to 1506. If a PDU associated with the NC process is not received, the receiving WTRU 102 may proceed to 1508.

At 1506, the receiving WTRU 102 may process the PDU. For example, the PDU may be processed as described at 1428 of FIG. 14.

At 1508, the receiving WTRU 102 may determine whether a NC process stuck timer of the NC process is expired. If the NC process stuck timer associated with the NC process is or has expired, the receiving WTRU 102 may proceed to 1510. If the NC process stuck timer associated with the NC process has not expired (e.g., is running), the receiving WTRU 102 may proceed to 1502.

At 1510, the receiving WTRU 102 may release the NC process. For example, the PDU may be processed as described at 1432 of FIG. 14. For example, to release the NC process (e.g., associated with the NC process stuck timer), the receiving WTRU 102 may discard all received and/or stored PDUs belonging to the NC PDU set (e.g., associated with the NC process).

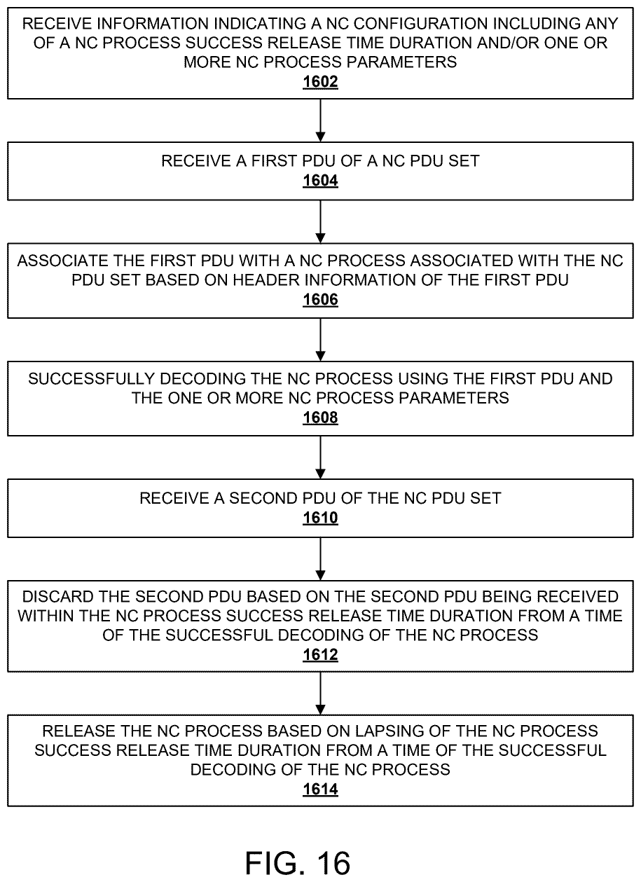

FIG. 16 is a procedural diagram illustrating an example NC process at a receiver (e.g., a receiving WTRU 102). At 1602, a receiving WTRU 102 may receive information indicating a NC configuration. For example, the NC configuration may include information indicating any of a NC process success release time duration and/or one or more NC process parameters. At 1604, the receiving WTRU 102 may receive a first PDU (e.g., of a NC PDU set). At 1606, the receiving WTRU 102 may associate the first PDU with a NC process (e.g., associated with the NC PDU set) based on header information of the first PDU. At 1608, the receiving WTRU 102 may successfully decode the NC process using the first PDU and the one or more NC process parameters. At 1610, the receiving WTRU 102 may receive a second PDU of the NC PDU set. At 1612, the receiving WTRU 102 may discard the second PDU based on the second PDU being received within the NC process success release time duration from a time of the successful decoding of the NC process. For example, the second PDU may be received in a time interval which starts with the successful decoding of the NC process and ends at a time which is the NC process success release time duration after the successful decoding of the NC process. At 1614, the receiving WTRU 102 may release the NC process based on lapsing of the NC process success release time duration from a time of the successful decoding of the NC process.

For example, the successful decoding of the NC process may include obtaining one or more SDUs encoded by the NC PDU set.

For example, the receiving WTRU 102 may, before receiving the first PDU, receive one or more third PDUs of the NC PDU set. The receiving WTRU 102 may initiate the NC process associated with the NC PDU set based on header information of the one or more third PDUs. The successful decoding of the NC process may use the first PDU, the one or more third PDUs, and the one or more NC process parameters.

For example, the receiving WTRU 102 may associate the first PDU with the NC process associated with the NC PDU set which includes initiating the NC process associated with the NC PDU set based on header information of the first PDU.

For example, the header information of the first PDU may include a PDCP sub-header including information indicating a NC PDU set sequence number and/or an order sequence number. For example, the one or more NC process parameters may include a range of NC PDU set sequence numbers corresponding to the NC PDU set.

For example, the receiving WTRU 102 may transmit a PDU discard indicator based on the discarding of the second PDU.

For example, the receiving WTRU 102 may transmit a NC process release indicator based on the releasing of the NC process.

For example, the receiving WTRU 102 may release the NC process which includes discarding any received PDUs associated with the NC process.

For example, the one or more NC process parameters may include coding coefficient information. The successful decoding of the NC process may use a subset of the coding coefficient information indicated by the first PDU.

For example, the NC configuration information may include information associated with a radio bearer and/or a PDCP entity. The first PDU may be received via the radio bearer and/or the header information of the first PDU indicates the PDCP entity.

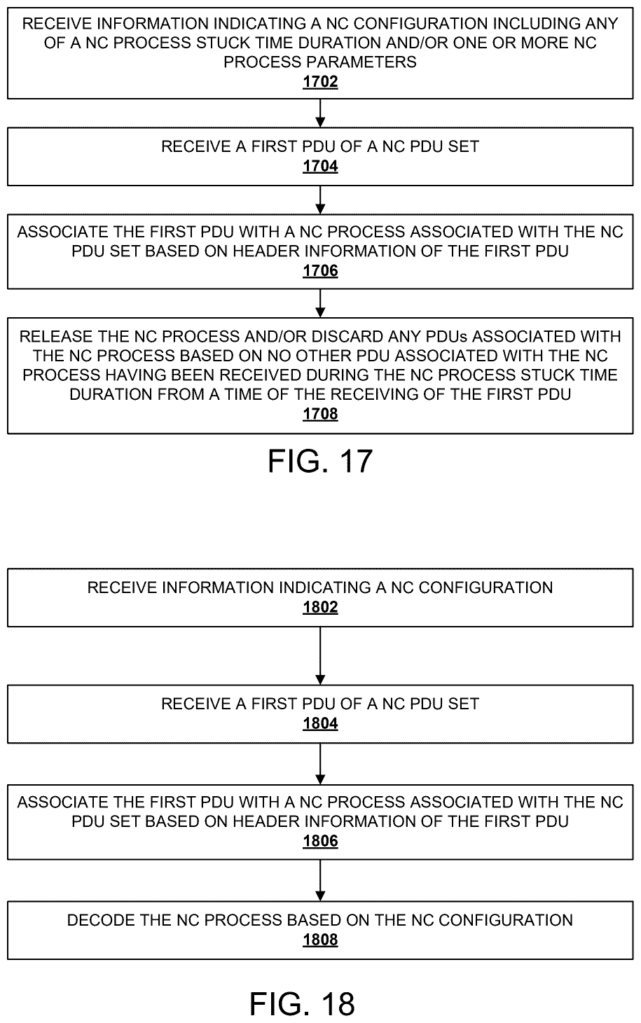

FIG. 17 is a procedural diagram illustrating another example NC process at a receiver (e.g., a receiving WTRU 102). As shown in FIG. 17, a receiving WTRU 102 may receive information indicating a NC configuration including any of a NC process stuck time duration and/or one or more NC process parameters at 1702. At 1704, the receiving WTRU 102 may receive a first PDU of a NC PDU set. At 1706, the receiving WTRU 102 may associate the first PDU with a NC process associated with the NC PDU set based on header information of the first PDU. At 1708, the receiving WTRU 102 may release the NC process and/or discard any PDUs associated with the NC process based on no other PDUs associated with the NC process having been received during the NC process stuck time duration from a time of the receiving of the first PDU.

FIG. 18 is a procedural diagram illustrating another example NC process at a receiver (e.g., a receiving WTRU 102). As shown in FIG. 18, a receiving WTRU 102 may receive information indicating a NC configuration at 1802. At 1804, the receiving WTRU 102 may receive a first PDU of a NC PDU set, at 1806, the receiving WTRU 102 may associate the first PDU with a NC process associated with the NC PDU set based on header information of the first PDU. At 1808, the receiving WTRU 102 may decode the NC process.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method implemented by a wireless transmit/receive unit (WTRU), the method comprising:
receiving information indicating a Network Coding (NC) configuration including any of a NC process success release time duration and/or one or more NC process parameters;
receiving a first protocol data unit (PDU) of a NC PDU set;
associating the first PDU with a NC process associated with the NC PDU set based on header information of the first PDU;
successfully decoding the NC process using the first PDU and the one or more NC process parameters;
receiving a second PDU of the NC PDU set;
discarding the second PDU based on the second PDU being received within the NC process success release time duration from a time of the successful decoding of the NC process; and
releasing the NC process based on lapsing of the NC process success release time duration from a time of the successful decoding of the NC process.

2. The method of claim 1, wherein the successful decoding of the NC process includes obtaining one or more service data units (SDUs) encoded by the NC PDU set.

3. The method of claim 1, further comprising:
before receiving the first PDU, receiving one or more third PDUs of the NC PDU set; and
initiating the NC process associated with the NC PDU set based on header information of the one or more third PDUs,
wherein the successful decoding of the NC process uses, the first PDU, the one or more third PDUs, and the one or more NC process parameters.

4. The method of claim 1, wherein the associating the first PDU with the NC process associated with the NC PDU set includes initiating the NC process associated with the NC PDU set based on header information of the first PDU.

5. The method of claim 1, wherein the header information of the first PDU includes a packet data convergence protocol (PDCP) sub-header including information indicating a NC PDU set sequence number and/or an order sequence number, and
wherein the one or more NC process parameters include a range of NC PDU set sequence numbers corresponding to the NC PDU set.

6. The method of claim 1, further comprising:
transmitting a PDU discard indicator based on the discarding of the second PDU.

7. The method of claim 1, further comprising:
transmitting a NC process release indicator based on the releasing of the NC process.

8. The method of claim 1, wherein the releasing of the NC process includes discarding any received PDUs associated with the NC process.

9. The method of claim 1, wherein the one or more NC process parameters include coding coefficient information, and
wherein the successful decoding of the NC process uses a subset of the coding coefficient information indicated by the first PDU.

10. The method of claim 1, wherein the NC configuration information includes information associated with a radio bearer and/or a packet data convergence protocol (PDCP) entity, and
wherein the first PDU is received via the radio bearer and/or the header information of the first PDU indicates the PDCP entity.

11. A wireless transmit/receive unit (WTRU) comprising:
a processor, memory, and a transceiver which are configured to:
receive information indicating a Network Coding (NC) configuration including any of a success release time duration and/or one or more NC process parameters,
receive a first protocol data unit (PDU) of a NC PDU set,
associate the first PDU with a NC process associated with the NC PDU set based on header information of the first PDU,
successfully decode the NC process using the first PDU and the one or more NC process parameters,
receive a second PDU of the NC PDU set,
discard the second PDU based on (i) the second PDU being received within the NC process success release time duration from a time of the successful decoding of the NC process or (ii) the second PDU being a duplicate of the first PDU, and
release the NC process based on lapsing of the NC process success release time duration from a time of the successful decoding of the NC process.

12. The WTRU of claim 11, wherein the processor, memory, and the transceiver are configured to the successfully decode the NC process which includes to obtain one or more service data units (SDUs) encoded by the NC PDU set.

13. The WTRU of claim 11, wherein the processor, memory, and the transceiver are configured to:
before receiving the first PDU, receive one or more third PDUs of the NC PDU set, and
initiate the NC process associated with the NC PDU set based on header information of the one or more third PDUs, and
wherein the processor, memory, and the transceiver are configured to the successfully decode the NC process using the first PDU, the one or more third PDUs, and the one or more NC process parameters.

14. The WTRU of claim 11, wherein the processor, memory, and the transceiver are configured to associate the first PDU with the NC process associated with the NC PDU set which includes to initiate the NC process associated with the NC PDU set based on header information of the first PDU.

15. The WTRU of claim 11, wherein the header information of the first PDU includes a packet data convergence protocol (PDCP) sub-header including information indicating a NC PDU set sequence number and/or an order sequence number, and
wherein the one or more NC process parameters include a range of NC PDU set sequence numbers corresponding to the NC PDU set.

16. The WTRU of claim 11, wherein the processor, memory, and the transceiver are configured to transmit a PDU discard indicator based on the discarding of the second PDU.

17. The WTRU of claim 11, wherein the processor, memory, and the transceiver are configured to transmit a NC process release indicator based on the releasing of the NC process.

18. The WTRU of claim 11, wherein the processor, memory, and the transceiver are configured to release the NC process which includes to discard any received PDUs associated with the NC process.

19. The WTRU of claim 11, wherein the one or more NC process parameters include coding coefficient information, and
wherein the processor, memory, and the transceiver are configured to successfully decode the NC process using a subset of the coding coefficient information indicated by the first PDU.

20. The WTRU of claim 11, wherein the NC configuration information includes information associated with a radio bearer and/or a packet data convergence protocol (PDCP) entity, and
wherein the first PDU is received via the radio bearer and/or the header information of the first PDU indicates the PDCP entity.
